(19) United States
(12) Patent Application Publication
(10) Pub. No.: US 2026/0243880 A1
(43) Pub. Date: Aug. 20, 2026

(54) ESTIMATING DEVICE, ESTIMATING METHOD, AND RECORDING MEDIUM

(71) Applicant: Panasonic Intellectual Property Management Co., Ltd., Osaka (JP)

(72) Inventors: Nobuyuki SHIRAKI, Hokkaido (JP); Takeshi NAKAYAMA, Hyogo (JP); Shoichi IIZUKA, Osaka (JP); Naoki HONMA, Iwate (JP); Takumi SHIMOFUSA, Iwate (JP)

(21) Appl. No.: 19/162,473

(22) PCT Filed: Jun. 24, 2024
(86) PCT No.: PCT/JP2024/022779

§ 371 Date: Sep. 5, 2025

(30) Foreign Application Priority Data
Jul. 4, 2023 (JP) 2023-110170

(51) Int. Cl. G01S 13/46; G06F 17/16

(52) U.S. Cl. CPC G01S 13/46; G06F 17/16

(57) ABSTRACT

An estimating device calculates a second complex transfer function matrix by performing predetermined processing on each of N×M×S elements in a first complex transfer function matrix that includes, as each element of an N×M×S three-dimensional array, complex transfer functions obtained for each of S subcarriers and each of N×M combinations. The predetermined processing is processing that calculates an amplitude average of a plurality of first elements including an element to be processed, and divides the element to be processed by the amplitude average. The plurality of first elements are included in S×M elements obtained for one reception antenna element corresponding to the element to be processed.

### TECHNICAL FIELD

The present disclosure relates to an estimating device, an estimating method, and so on, for estimating the distance or position to a living body by using radio signals.

### BACKGROUND ART

A method that uses radio signals is being considered as a method for knowing the position of a person (see for example, Patent Literature (PTL) 1 to 4). PTL 1, 2, and 3 disclose techniques of estimating the position and state of a person that is a detection target by analyzing a component including a Doppler shift using difference calculation. PTL 4 and 5 disclose Doppler sensors that use orthogonal frequency division multiplexing (OFDM) signals.

### CITATION LIST

### Patent Literature

[PTL 1] Japanese Unexamined Patent Application Publication No. 2015-117972
[PTL 2] Japanese Unexamined Patent Application Publication No. 2017-129558
[PTL 3] Japanese Unexamined Patent Application Publication No. 2018-008021
[PTL 4] Japanese Unexamined Patent Application Publication No. 2012-088279
[PTL 5] Japanese Unexamined Patent Application Publication No. 2012-137340

### Non Patent Literature

[NPL 1] H. Yamada, M. Ohmiya, Y. Ogawa and K. Itoh, “Superresolution techniques for time-domain measurements with a network analyzer,” in IEEE Transactions on Antennas and Propagation, vol. 39, no. 2, pp. 177-183, February 1991

### SUMMARY OF INVENTION

### Technical Problem

With the conventional methods, it is difficult to more accurately estimate the distance from the estimating device to a living body, the direction to the living body, etc.

### Solution to Problem

In order to achieve the above object, an estimating device according to one aspect of the present disclosure includes: a transmission signal generator that generates a multicarrier signal obtained by modulating S subcarrier signals, where S is a natural number greater than or equal to 2; a transmission antenna including M transmission antenna elements, where M is a natural number greater than or equal to 1; a transmitter that causes the transmission antenna to transmit the multicarrier signal, by processing and outputting the multicarrier signal to the transmission antenna; a reception antenna including N reception antenna elements, where N is a natural number greater than or equal to 1; a receiver that measures, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or scattered by the living body, and calculates, for each of S subcarriers to which the S subcarrier signals correspond, complex transfer functions indicating a propagation characteristic between a transmission antenna element and a reception antenna element in each of N×M combinations which are combinations of each of the M transmission antenna elements and each of the N reception antenna elements, using the plurality of reception signals measured in the first period; and a matrix calculator that calculates a second complex transfer function matrix by performing predetermined processing on each of N×M×S elements in a first complex transfer function matrix that includes, as elements of an N×M×S three-dimensional array, the complex transfer functions obtained for each of the S subcarriers and each of the N×M combinations, wherein the predetermined processing is processing that calculates an amplitude average of a plurality of first elements including an element to be processed, and divides the element to be processed by the amplitude average, and the plurality of first elements are included in S×M elements obtained for one reception antenna element, among the N reception antenna elements, that corresponds to the element to be processed.

An estimating method according to one aspect of the present disclosure is performed by an estimating device including a transmission antenna including M transmission antenna elements, where M is a natural number greater than or equal to 1, and a reception antenna including N reception antenna elements, where N is a natural number greater than or equal to 1, and includes: generating a multicarrier signal obtained by modulating S subcarrier signals, where S is a natural number greater than or equal to 2; causing the transmission antenna to transmit the multicarrier signal, by processing and outputting the multicarrier signal to the transmission antenna; measuring, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or scattered by the living body; calculating, for each of S subcarriers to which the S subcarrier signals correspond, complex transfer functions indicating a propagation characteristic between a transmission antenna element and a reception antenna element in each of N×M combinations which are combinations of each of the M transmission antenna elements and each of the N reception antenna elements, using the plurality of reception signals measured in the first period; and calculating a second complex transfer function matrix by performing predetermined processing on each of N×M×S elements in a first complex transfer function matrix that includes, as elements of an N×M×S three-dimensional array, the complex transfer functions obtained for each of the S subcarriers and each of the N×M combinations, wherein the predetermined processing is processing that calculates an amplitude average of a plurality of first elements including an element to be processed, and divides the element to be processed by the amplitude average, and the plurality of first elements are included in S×M elements obtained for one reception antenna element, among the N reception antenna elements, that corresponds to the element to be processed.

It should be noted that these general and specific aspects may be implemented using a system, an integrated circuit, a computer program, or a computer-readable recording medium such as a CD-ROM, or any combination of an apparatus, a system, a method, an integrated circuit, a computer program, or a recording medium.

### Advantageous Effects of Invention

According to the present disclosure, it is possible to more accurately estimate the position and the like of a living body.

### BRIEF DESCRIPTION OF DRAWINGS

FIG. 1 is a block diagram illustrating an example of a configuration of an estimating device according to Embodiment 1.

FIG. 2 is a diagram for explaining the relationship between transmission signal, channel, and reception signal.

FIG. 3 is a diagram for explaining propagation characteristics at different time points in a MIMO system.

FIG. 4 is a schematic diagram illustrating a first error.

FIG. 5 illustrates an example of a first error.

FIG. 6 is a schematic diagram illustrating a second error.

FIG. 7 illustrates an example of a second error.

FIG. 8 is a schematic diagram illustrating a third error.

FIG. 9 is a schematic diagram illustrating the relationship between a third error and a channel.

FIG. 10 is a schematic diagram illustrating the relationship between frequency and phase difference slope.

FIG. 11 is a schematic diagram illustrating phases of a time domain living body component transfer function matrix.

FIG. 12 is a schematic diagram illustrating the position of a living body and the positional relationship between the living body and transmission and reception antennas in a MIMO system.

FIG. 13 is a schematic diagram illustrating the position of a living body and the positional relationship between the living body, a plurality of transmission antennas, and a reception antenna in a MISO system.

FIG. 14 is a flowchart illustrating the estimation process by the estimating device according to Embodiment 1.

FIG. 15 is a block diagram illustrating an example of a configuration of an estimating device according to Embodiment 2.

FIG. 16 is a diagram for explaining propagation characteristics at different time points in a SIMO system.

FIG. 17 is a schematic diagram illustrating the position of a living body and the positional relationship between the living body and transmission and reception antennas in a SIMO system.

FIG. 18 is a schematic diagram illustrating the position of a living body and the positional relationship between the living body and transmission and reception antennas in a SISO system.

FIG. 19 is a flowchart illustrating the estimation process by the estimating device according to Embodiment 2.

FIG. 20 illustrates conditions of an experiment using the estimating method according to Embodiment 1.

FIG. 21 illustrates an example of an estimation result of the estimating method according to Embodiment 1.

FIG. 22 illustrates an example of estimation error statistics of the estimating method according to Embodiment 1.

### DESCRIPTION OF EMBODIMENTS

### (Underlying Knowledge Forming Basis of the Present Disclosure)

A method that uses radio signals is being considered as a method for knowing the position of a person.

For example, PTL 1 and 2 disclose transmitting a radio signal over a predetermined area, receiving, using antennas, the radio signal reflected at a detection target, and estimating a complex transfer function between transmission and reception antennas. A complex transfer function is a function including complex numbers representing a relationship between input and output, and represents propagation characteristics between transmission and reception antennas. The number of elements of the complex transfer function is equivalent to the product of the number of transmission antennas and the number of reception antennas. In addition, PTL 3 discloses estimating the posture of a living body by using a radar cross-section (RCS) calculated from received power, with the same configuration as in PTL 2. RCS is an index indicating the area of an object that reflected a transmission wave, and the RCS of a living body changes in various ways according to the posture of the living body.

PTL 1 discloses a processing device that can know the position or state of a person that is a detection target by analyzing a component including a Doppler shift, using Fourier transform. More specifically, the processing device records the temporal change of an element of a complex transfer function, and the temporal waveform thereof is Fourier-transformed. Through biological activity such as respiration or heartbeat, a living body such as a person exerts a small Doppler effect on the reflected wave reflected by the living body. Therefore, a component including a Doppler shift obtained from the reflected wave includes the influence of the living body. However, a component that does not include a Doppler shift obtained from the reflected wave is not influenced by the living body. Stated differently, a component that does not include a Doppler shift corresponds to a reflected wave from a fixed object or a direct wave between transmission and reception antennas. Specifically, the position or state of a person that is a detection target is obtained by using a component included in a predetermined frequency range in a Fourier-transformed waveform.

PTL 2 discloses a method of recording a temporal change in an element of a complex transfer function, and extracting a component including a small Doppler shift including the influence of a living body by analyzing difference information of the temporal change. Specifically, in this method, it is possible to know the position or state of a person that is a detection target by using the difference information.

In contrast, PTL 3 discloses an OFDM Doppler radar that transmits a pulse using an OFDM signal, and detects a Doppler shift caused by a traveling body that is a target. Furthermore, PTL 4 discloses, with regard to an OFDM Doppler radar, a high-speed processing method that does not require Fourier transform.

Furthermore, PTL 4 and 5 disclose techniques for improving the accuracy of estimation of complex transfer functions between transmission and reception antennas, by transmitting an OFDM signal. PTL 5 discloses that received noise components can be reduced by averaging complex transfer functions on a subcarrier basis.

However, in the methods in PTL 1, 2, and 3, non-modulated waves are transmitted, and thus it is difficult to make use of commercially available devices, and dedicated hardware is required. Specifically, it is not possible to use communication devices that are currently widely used, and thus a user needs to additionally provide dedicated hardware aside from an existing communication device.

Furthermore, in order to obtain sufficient accuracy with the methods in PTL 4 and 5, it is necessary to make pulses steep, which requires a wide frequency band. As such, the cost of hardware is more expensive compared to communication devices for public use.

In the technique in NPL 1, by transmitting and receiving signals having a plurality of frequencies using a measuring device such as a network analyzer, it is possible to estimate the time of flight (ToF) or distance, which can be computed from the ToF, between a transmission antenna and a reception antenna. As in a ranging sensor that uses a frequency modulated continuous wave (FMCW) radar, this makes use of the property in which, when two signals having different frequencies are transmitted at the same phase, the phase received by the reception antenna changes depending on the frequency difference between signals and the propagation distance between the antennas. The technique in NPL 1 improves resolution by performing ToF estimation using the multiple signal classification (MUSIC) method.

However, it is necessary for the transmission side and reception side to either operate with the same reference frequency or be synchronized with high accuracy, and thus it is difficult to apply this technology to household appliances connected via, for example, a wireless LAN. Furthermore, only the distance between antennas can be estimated, and, for example, it is difficult to estimate the distance between a living body that is not equipped with a special device and a device.

The inventors of the present disclosure developed an estimating device, etc., capable of more accurately estimating the position and the like of a living body.

An estimating device according to a first aspect of the present disclosure includes: a transmission signal generator that generates a multicarrier signal obtained by modulating S subcarrier signals, where S is a natural number greater than or equal to 2; a transmission antenna including M transmission antenna elements, where M is a natural number greater than or equal to 1; a transmitter that causes the transmission antenna to transmit the multicarrier signal, by processing and outputting the multicarrier signal to the transmission antenna; a reception antenna including N reception antenna elements, where N is a natural number greater than or equal to 1; a receiver that measures, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or scattered by the living body, and calculates, for each of S subcarriers to which the S subcarrier signals correspond, complex transfer functions indicating a propagation characteristic between a transmission antenna element and a reception antenna element in each of N×M combinations which are combinations of each of the M transmission antenna elements and each of the N reception antenna elements, using the plurality of reception signals measured in the first period; and a matrix calculator that calculates a second complex transfer function matrix by performing predetermined processing on each of N×M×S elements in a first complex transfer function matrix that includes, as elements of an N×M×S three-dimensional array, the complex transfer functions obtained for each of the S subcarriers and each of the N×M combinations, wherein the predetermined processing is processing that calculates an amplitude average of a plurality of first elements including an element to be processed, and divides the element to be processed by the amplitude average, and the plurality of first elements are included in S×M elements obtained for one reception antenna element, among the N reception antenna elements, that corresponds to the element to be processed.

With this, predetermined processing that calculates an amplitude average of a plurality of first elements that are included in S×M elements obtained for one reception antenna element corresponding to the element to be processed and that include the element to be processed, and divides the element to be processed by the amplitude average, is performed on each of N×M×S elements in the first complex transfer function matrix, so that a first error given to a reception signal by the reception antenna element can be reduced for each reception antenna element. Therefore, it is possible to accurately estimate the position and the like of a living body.

Also, with this configuration, a living body radar that measures distance and/or position to a living body can be realized by repurposing an existing communication device by using a multicarrier signal such as an OFDM signal as a transmission signal. For example, reception devices of multicarrier signals such as OFDM signals are already widely used as mobile phones, television broadcast reception devices, wireless LAN devices, and so on, and thus a living body radar that measures the distance and/or position to a living body can be realized at a lower cost than when non-modulated signals are used.

An estimating device according to a second aspect of the present disclosure is the estimating device according to the first aspect, wherein the plurality of first elements are M elements obtained for the one reception antenna element corresponding to the element to be processed and one subcarrier, among the S subcarriers, that corresponds to the element to be processed.

Accordingly, by using an amplitude average of M elements obtained for one reception antenna element corresponding to the element to be processed and one subcarrier corresponding to the element to be processed, the first error can be reduced.

An estimating device according to a third aspect of the present disclosure is the estimating device according to the first aspect, wherein the plurality of first elements are S elements obtained for the one reception antenna element corresponding to the element to be processed and one transmission antenna element, among the M transmission antenna elements, that corresponds to the element to be processed.

Accordingly, by using an amplitude average of S elements obtained for one reception antenna element corresponding to the element to be processed and one transmission antenna element corresponding to the element to be processed, the first error can be reduced.

An estimating device according to a fourth aspect of the present disclosure is the estimating device according to the first aspect, wherein the plurality of first elements are the S×M elements.

Accordingly, by using an amplitude average of S×M elements, the first error can be reduced.

An estimating device according to a fifth aspect of the present disclosure is the estimating device according to any one of the first to third aspects, wherein the matrix calculator further calculates an offset value with respect to a reference phase calculated from a positional relationship between the transmission antenna and the reception antenna, and calculates a third complex transfer function matrix in which the second complex transfer function matrix is corrected based on the offset value.

With this, the third error with respect to the reference phase can be reduced, and therefore it is possible to more accurately estimate the position and the like of a living body.

An estimating device according to a sixth aspect of the present disclosure is the estimating device according to the fifth aspect, wherein the matrix calculator: converts the second complex transfer function matrix to a frequency response matrix or a frequency response vector, and extracts a frequency response matrix or a frequency response vector corresponding to a direct wave between the transmission antenna and the reception antenna; calculates an ideal complex transfer function corresponding to the direct wave, and based on (i) the ideal complex transfer function and (ii) the frequency response matrix or the frequency response vector, calculates, as the offset value, a correction value for correcting a phase error in S second elements for each of the N×M combinations in the second complex transfer function matrix; and calculates the third complex transfer function matrix in which the phase error is corrected based on the correction value.

Accordingly, phase error in the subcarrier direction can be removed, and thus the distance from the estimating device to the living body can be more accurately estimated.

An estimating device according to a seventh aspect of the present disclosure is the estimating device according to the fifth aspect, wherein the matrix calculator: calculates an average value of all elements or a plurality of third elements of the second complex transfer function matrix by performing averaging in each of a real part direction and an imaginary part direction; calculates an ideal complex transfer function corresponding to a direct wave between the transmission antenna and the reception antenna, and based on the ideal complex transfer function and the average value, calculates, as the offset value, a correction value for correcting a phase error in S second elements for each of the N×M combinations in the second complex transfer function matrix; and calculates the third complex transfer function matrix in which the phase error is corrected based on the correction value.

Accordingly, phase error in the subcarrier direction can be removed, and thus the distance from the estimating device to the living body can be more accurately estimated.

An estimating device according to an eighth aspect of the present disclosure is the estimating device according to any one of the fifth to seventh aspects, wherein the matrix calculator further calculates a fourth complex transfer function matrix by applying, to the second complex transfer function matrix or the third complex transfer function matrix, a time-direction Minimum Mean Square Error (MMSE) filter in which a direct wave between the transmission antenna and the reception antenna is set as a reference signal.

Accordingly, phase error in the subcarrier direction can be removed, and thus the distance from the estimating device to the living body can be more accurately estimated.

An estimating device according to a ninth aspect of the present disclosure is the estimating device according to the first aspect, wherein the first complex transfer function matrix includes N×M×S corrected elements obtained by dividing all elements of N×M×S complex transfer functions by a direct wave component that has not arrived via the living body and is extracted using one or more elements of the N×M×S complex transfer functions, the N×M×S complex transfer functions being a set of the complex transfer functions obtained for each of the S subcarriers and each of the N×M combinations.

With this, a first error, which is a component corresponding to at least one of the following, can be reduced: (1) clock fluctuations between a transmission device including a transmission signal generator that transmits from a transmission antenna and a transmitter, and a reception device including a receiver that receives via a reception antenna; or (2) timing fluctuations in digital-to-analog conversion of the transmission signal or analog-to-digital conversion of the reception signal. Therefore, it is possible to more accurately estimate the position and the like of a living body.

An estimating device according to a tenth aspect of the present disclosure is the estimating device according to any one of the fifth to eighth aspects, wherein M and N are each greater than or equal to 2, and the estimating device further includes an estimator that, using the third complex transfer function matrix calculated by the matrix calculator, estimates a position of the living body from a first angle and a second angle, the first angle indicating a direction of the living body as seen from the M transmission antenna elements, the second angle indicating a direction of the living body as seen from the N reception antenna elements.

Accordingly, the position of the living body relative to the estimating device can be more accurately estimated.

An estimating device according to an eleventh aspect of the present disclosure is the estimating device according to any one of the fifth to eighth aspects, wherein at least one of M or N is greater than or equal to 2, and the estimating device further includes an estimator that, using the third complex transfer function matrix calculated by the matrix calculator, estimates a third distance that is a sum of a first distance between the transmission antenna and the living body and a second distance between the reception antenna and the living body, estimates a first angle or a second angle indicating a direction of the living body as seen from two or more antenna elements included in the transmission antenna or the reception antenna, and estimates a position of the living body from the third distance and the first angle or the second angle.

Accordingly, the position of the living body relative to the estimating device can be more accurately estimated.

An estimating device according to a twelfth aspect of the present disclosure is the estimating device according to any one of the fifth to eighth aspects, wherein M and N are each 1, and the estimating device further includes an estimator that, using the third complex transfer function matrix calculated by the matrix calculator, estimates a third distance that is a sum of a first distance between the transmission antenna and the living body and a second distance between the reception antenna and the living body.

Accordingly, the distance to the living body relative to the estimating device can be more accurately estimated.

An estimating device according to a thirteenth aspect of the present disclosure is the estimating device according to the eleventh aspect, wherein the estimator estimates the first distance, the second distance, the first angle, and the second angle using any one of a multiple signal classification (MUSIC) method, a beamformer method, or Capon method.

Accordingly, the distance to the living body relative to the estimating device can be more accurately estimated.

An estimating method according to a fourteenth aspect of the present disclosure is performed by an estimating device including a transmission antenna including M transmission antenna elements, where M is a natural number greater than or equal to 1, and a reception antenna including N reception antenna elements, where N is a natural number greater than or equal to 1, and includes: generating a multicarrier signal obtained by modulating S subcarrier signals, where S is a natural number greater than or equal to 2; causing the transmission antenna to transmit the multicarrier signal, by processing and outputting the multicarrier signal to the transmission antenna; measuring, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or scattered by the living body; calculating, for each of S subcarriers to which the S subcarrier signals correspond, complex transfer functions indicating a propagation characteristic between a transmission antenna element and a reception antenna element in each of N×M combinations which are combinations of each of the M transmission antenna elements and each of the N reception antenna elements, using the plurality of reception signals measured in the first period; and calculating a second complex transfer function matrix by performing predetermined processing on each of N×M×S elements in a first complex transfer function matrix that includes, as elements of an N×M×S three-dimensional array, the complex transfer functions obtained for each of the S subcarriers and each of the N×M combinations, wherein the predetermined processing is processing that calculates an amplitude average of a plurality of first elements including an element to be processed, and divides the element to be processed by the amplitude average, and the plurality of first elements are included in S×M elements obtained for one reception antenna element, among the N reception antenna elements, that corresponds to the element to be processed.

With this, predetermined processing that calculates an amplitude average of a plurality of first elements that are included in S×M elements obtained for one reception antenna element corresponding to the element to be processed and that include the element to be processed, and divides the element to be processed by the amplitude average, is performed on each of N×M×S elements in the first complex transfer function matrix, so that a first error given to a reception signal by the reception antenna element can be reduced for each reception antenna element. Therefore, it is possible to accurately estimate the position and the like of a living body.

Also, with this configuration, a living body radar that measures distance and/or position to a living body can be realized by repurposing an existing communication device by using a multicarrier signal such as an OFDM signal as a transmission signal. For example, reception devices of multicarrier signals such as OFDM signals are already widely used as mobile phones, television broadcast reception devices, wireless LAN devices, and so on, and thus a living body radar that measures the distance and/or position to a living body can be realized at a lower cost than when non-modulated signals are used.

A program according to a fifteenth aspect of the present disclosure is a program for causing a computer to execute the estimating method according to the fourteenth aspect.

With this configuration, a living body radar that measures distance and/or position to a living body can be realized by repurposing an existing communication device by using a multicarrier signal such as an OFDM signal as a transmission signal. For example, reception devices of multicarrier signals such as OFDM signals are already widely used as mobile phones, television broadcast reception devices, wireless LAN devices, and so on, and thus a living body radar that measures the distance and/or position to a living body can be realized at a lower cost than when non-modulated signals are used.

It should be noted that these generic and specific aspects may be implemented using a system, an integrated circuit, a computer program, or a computer-readable recording medium such as a CD-ROM, or any combination of an apparatus, a system, a method, an integrated circuit, a computer program, or a recording medium.

Hereinafter, exemplary embodiments of the present disclosure will be described in detail with reference to the Drawings. It should be noted that each of the exemplary embodiments described hereinafter illustrate a specific example of the present disclosure. The numerical values, shapes, materials, elements, the arrangement and connection of the elements, steps, the processing order of the steps, etc., shown in the following exemplary embodiments are mere examples, and are therefore not intended to limit the present disclosure. Furthermore, among elements in the following exemplary embodiments, those not recited in any one of the independent claims defining the most generic concept of the present disclosure are described as optional elements making up a more preferable form. It should be noted that in the Specification and the Drawings, elements having substantially the same functional configuration are given the same numerical sign in order to omit overlapping descriptions.

### Embodiment 1

In Embodiment 1, a method for detecting a living body in the case of a multiple input multiple output (MIMO) scheme in which both the transmission antenna and the reception antenna include a plurality of antenna elements will be described. The present disclosure can similarly be applied to a multiple input single output (MISO) scheme in which there are a plurality of transmission antenna elements and a single reception antenna element.

### [Configuration of Estimating Device 101]

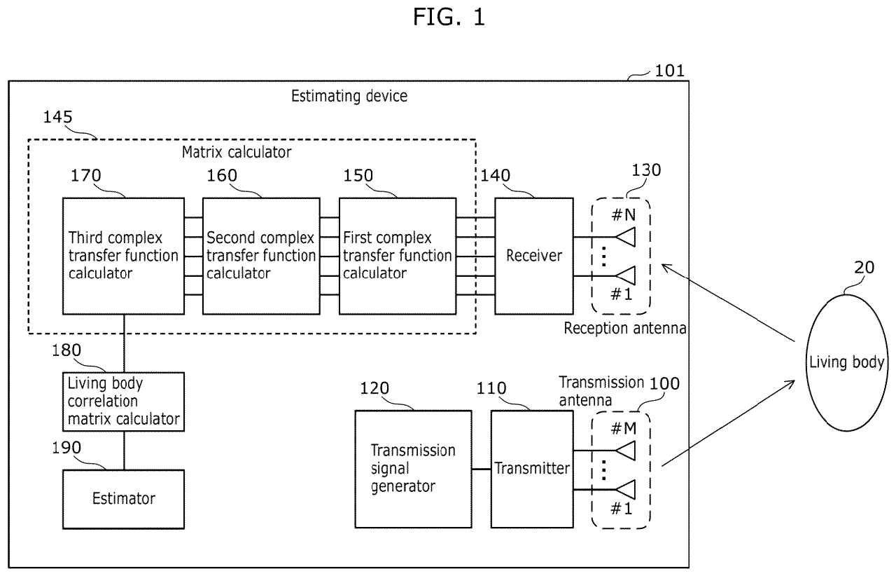

FIG. 1 is a block diagram illustrating an example of a configuration of an estimating device according to Embodiment 1.

Estimating device 101 illustrated in FIG. 1 includes transmission antenna 100, transmitter 110, transmission signal generator 120, reception antenna 130, receiver 140, matrix calculator 145, living body correlation matrix calculator 180, and estimator 190. Matrix calculator 145 includes first complex transfer function calculator 150, second complex transfer function calculator 160, and third complex transfer function calculator 170. Estimating device 101 estimates the position of living body 20. It should be noted that estimating device 101 may estimate the position of living body 20 in the target space, may estimate the posture of living body 20, may determine whether or not living body 20 is present in the target space, may identify living body 20 based on information (a complex transfer function matrix) registered in advance for each individual living body 20, or may estimate the movement of living body 20.

### [Transmission Antenna 100]

Transmission antenna 100 includes M transmission antenna elements. Here, M is a natural number greater than or equal to 1. Note that in the present embodiment, since MIMO or MISO is being discussed as described above, M is a natural number greater than or equal to 2. As described above, the transmission antenna element transmits a multicarrier signal (transmission wave) generated by transmitter 110 to be described later.

### [Transmission Signal Generator 120]

Transmission signal generator 120 generates a multicarrier signal obtained by modulating a plurality of subcarrier signals. Specifically, transmission signal generator 120 generates a plurality of subcarrier signals corresponding to a plurality of subcarriers having mutually different frequency bands, and generates a multicarrier signal by multiplexing the generated plurality of subcarrier signals. In the present embodiment, an example will be given in which transmission signal generator 120 generates, as a multicarrier signal, an OFDM signal of S subcarriers, which offers high frequency band utilization efficiency. Note that transmission signal generator 120 is not limited to generating an OFDM signal in which respective subcarriers are orthogonal, and may generate other multicarrier signals such as a simple frequency division multiplexing (FDM) signal as long as it is a multicarrier signal obtainable by multicarrier modulation.

Furthermore, the signal generated by transmission signal generator 120 may be a signal that is shared with a signal used for communication. Stated differently, the transmission signal used for sensing living body 20 may be used exclusively for sensing living body 20, or may be used for both sensing living body 20 and for communicating information.

### [Transmitter 110]

Transmitter 110 adds appropriate processing to the signal generated by transmission signal generator 120, to generate a transmission wave. The processing carried out here includes, for example, up-conversion in which the signal is converted from the intermediate frequency (IF) frequency band to the radio frequency (RF) frequency band, amplification in which the signal is amplified to the appropriate transmission level, etc. Transmitter 110 outputs the processed multicarrier signal to transmission antenna 100 to thereby cause transmission antenna 100 to transmit the multicarrier signal. With this, the multicarrier signal is transmitted from the M transmission antenna elements included in transmission antenna 100.

### [Reception Antenna 130]

Reception antenna 130 includes N reception antenna elements. Here, N is a natural number greater than or equal to 1. Note that in the present embodiment, N in the case of MIMO is a natural number greater than or equal to 2, and N in the case of MISO is 1. The N reception antenna elements receive signals that were transmitted by the M transmission antenna elements and reflected by living body 20 (i.e., reception signals 320 to be described later).

### [Receiver 140]

Receiver 140 measures, for a first period equivalent to a cycle derived from an activity of living body 20, reception signals 320 that are received by the N reception antenna elements and include reflected signals which are the multicarrier signals transmitted from the M transmission antenna elements that have been reflected or scattered by living body 20. A cycle derived from the activity of the living body is a living body-derived cycle (living body fluctuation cycle) which is a time period greater than or equal to a half-cycle of any of the cycles of respiration, heartbeat, and body motion of living body 20.

Receiver 140 converts the high-frequency signal received by the N reception antenna elements into a low-frequency signal on which signal processing can be performed. Receiver 140 includes N amplifiers, with each amplifier configured to amplify the signal received by its corresponding reception antenna element among the N reception antenna elements. Stated differently, the N amplifiers correspond one to one with the N reception antenna elements. Receiver 140 then demodulates the OFDM signal into S subcarrier signals (IQ symbols).

Receiver 140 further calculates, from the plurality of IQ symbols measured in the first period, a plurality of complex transfer functions indicating propagation characteristics between transmission antenna elements and reception antenna elements for each subcarrier.

Note that receiver 140 may continue to measure reception signal 320 already received by reception antenna 130, and continuously or periodically output S low-frequency signals (IQ symbols).

Receiver 140 calculates, for each of a plurality of subcarriers to which the plurality of subcarrier signals correspond, a plurality of complex transfer functions indicating a propagation characteristic between a transmission antenna element and a reception antenna element in each of N×M combinations which are combinations of each of the M transmission antenna elements and each of the N reception antenna elements, using the plurality of reception signals 320 measured in the first period. It should be noted that the N×M combinations are all the obtainable one-to-one combinations between the M transmission antenna elements and the N reception antenna elements.

In the present embodiment, receiver 140 calculates, using the S subcarrier signals, N×M×S sets of complex transfer functions indicating the propagation characteristics between each of the transmission antenna elements and each of the reception antenna elements, for each of the S subcarrier signals. In this way, receiver 140 may generate a complex transfer function matrix having N×M×S elements. It should be noted that the calculated complex transfer function matrix also includes reflected waves that did not arrive via living body 20, such as direct waves and reflected waves derived from a fixed object.

Note that receiver 140 may constantly calculate the complex transfer function matrix using each of the plurality of subcarrier signals that are outputted continuously or on a regular basis. By adopting this configuration, when estimating device 101 shares the hardware of a communication device, the complex transfer function matrix that is normally calculated for use in processing by the communication device can also be used by estimating device 101.

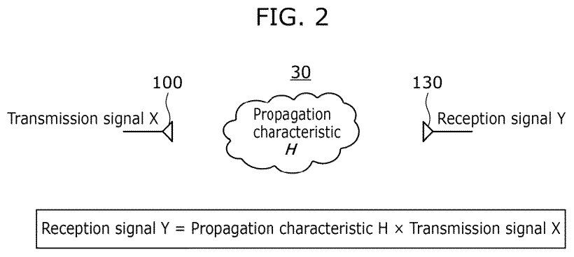

FIG. 2 is a diagram for explaining the relationship between transmission signal, channel, and reception signal.

Transmission signal X transmitted from transmission antenna 100 propagates through target space 30, is received by reception antenna 130, and is obtained as reception signal Y. Reception signal Y received by reception antenna 130 is a signal that has changed as transmission signal X propagates through target space 30. Accordingly, reception signal Y can be considered to be equal to a signal obtained by multiplying propagation characteristic H of target space 30 and transmission signal X. Propagation characteristic H is expressed using the above-described N×M×S sets of complex transfer functions.

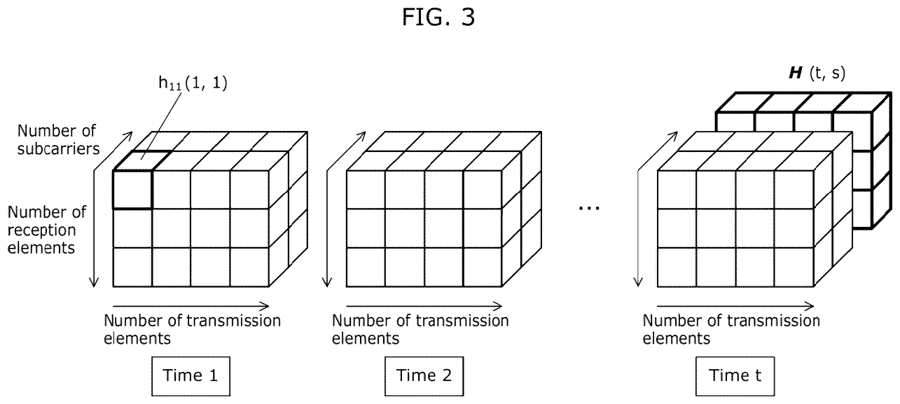

FIG. 3 is a diagram for explaining propagation characteristics at different time points in a MIMO system.

As described above, propagation characteristic H includes a complex transfer function for each combination of three types of parameters: each reception antenna element, each transmission antenna element, and each subcarrier. Stated differently, different complex transfer functions are calculated for each of a plurality of different reception antenna elements, different complex transfer functions are calculated for each of a plurality of different transmission antenna elements, and different complex transfer functions are calculated for each of a plurality of different subcarriers.

FIG. 3 illustrates an image of propagation characteristic H expressed by a combination of complex transfer functions in the case where the number of reception antenna elements is three, the number of transmission antenna elements is four, and the number of subcarriers is two. Propagation characteristic H in this case can be expressed as a combination of 3×4×2 blocks. One block represents one complex transfer function calculated for one specific reception antenna element, one specific transmission antenna element, and one specific subcarrier. In this way, propagation characteristic H can be expressed three-dimensionally because it is represented as a combination of three types of parameters: reception antenna element, transmission antenna element, and subcarrier. Furthermore, this three-dimensionally expressed propagation characteristic H is calculated for each of a plurality of timings. Stated differently, propagation characteristic H is represented by a complex transfer function matrix that includes, as each element of an N× M×S three-dimensional array, complex transfer functions obtained for each of the S subcarriers and each of the N×M combinations.

It should be noted that with the subcarrier and transmission antenna element fixed, a plurality of complex transfer functions of different reception antenna elements may be expressed as a plurality of complex transfer functions that are different in the reception antenna element direction. Similarly, with the subcarrier and reception antenna element fixed, a plurality of complex transfer functions of different transmission antenna elements may be expressed as a plurality of complex transfer functions that are different in the transmission antenna element direction. Similarly, with the reception antenna element and transmission antenna element fixed, a plurality of complex transfer functions of different subcarriers may be expressed as a plurality of complex transfer functions that are different in the subcarrier direction. In this manner, in propagation characteristic H expressed three-dimensionally, each dimensional direction may be expressed as reception antenna element direction, transmission antenna element direction, and subcarrier direction, using names related to three types of parameters.

For example, if rows of a matrix representing propagation characteristic H are assigned to reception antenna elements among the three dimensions and columns are assigned to transmission antenna elements, furthermore, different propagation characteristics H will be calculated for each subcarrier and for each obtainment timing of the reception signal. Stated differently, in the present embodiment, propagation characteristic H(t,s) between M transmission antenna elements and N reception antenna elements for the s-th subcarrier in the period of measurement time t is represented by a complex transfer function matrix as illustrated in Equation 1. This is determined from the S subcarrier signals transmitted from receiver 140.

$$\begin{matrix}[ Math . 1 ] & \\ H ( t , s ) = ( \begin{matrix}{h}_{11} ( t , s ) & ⋯ & {h}_{1 M} ( t , s ) \\ ⋮ & ⋱ & ⋮ \\ {h}_{N 1} ( t , s ) & ⋯ & {h}_{NM} ( t , s )\end{matrix} ) & ( Equation 1 )\end{matrix}$$

### [First Complex Transfer Function Calculator 150]

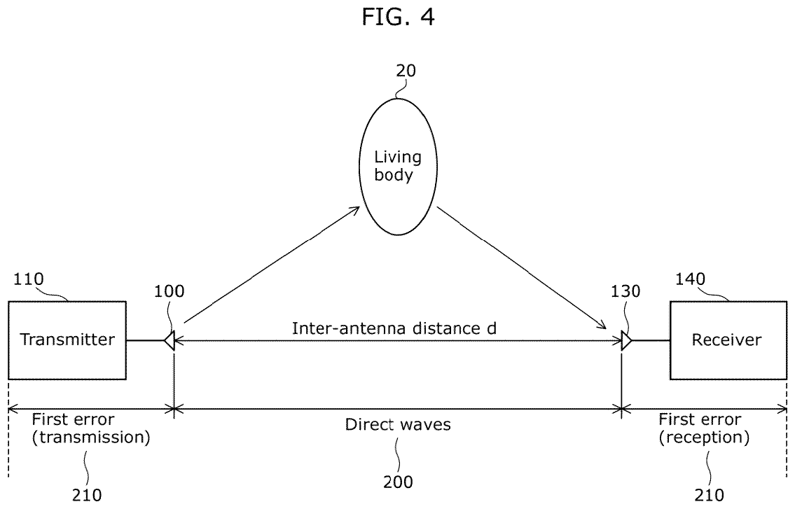

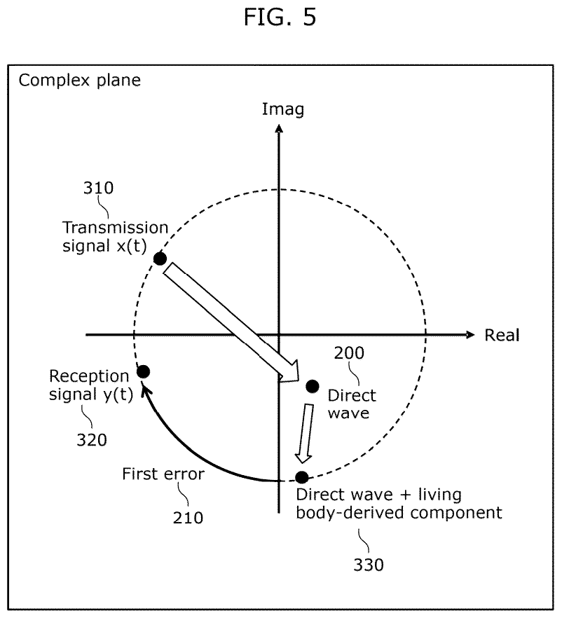

FIG. 4 and FIG. 5 are diagrams schematically illustrating an example of a first error.

First complex transfer function calculator 150 calculates a first complex transfer function matrix in which first error 210 corresponding to at least one of the following is inhibited from the complex transfer function matrix: (i) clock fluctuations between transmitter 110 and receiver 140 or (ii) timing fluctuations in digital-to-analog conversion of transmission signal 310 or analog-to-digital conversion of reception signal 320. Reception signal 320 includes temporally random first error 210 with respect to direct wave+living body-derived component 330 that includes direct wave 200 and a living body-derived component.

First complex transfer function calculator 150 calculates N×M×S corrected elements by dividing all elements of N×M×S complex transfer functions by a direct wave component that has not arrived via living body 20 and is extracted using one or more elements of the N×M×S complex transfer functions, the N×M×S complex transfer functions being a set of the complex transfer functions obtained for each of the S subcarriers and each of the N×M combinations. In this way, first complex transfer function calculator 150 generates a first complex transfer function matrix having N×M×S corrected elements.

More specifically, first complex transfer function calculator 150 obtains eigenvectors by performing eigenvalue decomposition of a correlation matrix of the complex transfer function over a fixed measurement period or the entire measurement period of the complex transfer function, and then calculates a first complex transfer function from a first eigenvector. From propagation characteristic H(t,s) at the s-th subcarrier, reception direction correlation matrix R_{R}(s) and transmission direction correlation matrix R_{T}(s) are calculated as illustrated in Equation 2 and Equation 3, respectively.

$$\begin{matrix}[ Math . 2 ] & \\ {R}_{R} ( s ) = H ( {t}_{0} , s ) {H}^{H} ( {t}_{0} , s ) & ( Equation 2 )\end{matrix}$$

$$\begin{matrix}[ Math . 3 ] & \\ {R}_{T} ( s ) = {H}^{H} ( {t}_{0} , s ) H ( {t}_{0} , s ) & ( Equation 3 )\end{matrix}$$

Here, t₀ represents instantaneous measurement time.

First complex transfer function calculator 150 performs eigenvalue decomposition of the transmission correlation matrix and the reception correlation matrix, and calculates transmission first eigenvector v₁(s) and reception first eigenvector u₁(s). An element of the first complex transfer function where the s-th subcarrier is transmitted from the m-th transmission antenna and received by the n-th reception antenna is calculated by Equation 4.

$$\begin{matrix}[ Math . 4 ] & \\ {h}_{nm}^{′} ( t , s ) = \frac{{h}_{nm} ( t , s )}{{u}_{1}^{H} ( s ) {h}_{nm} ( {t}_{0} , s ) {v}_{1} ( s )} & ( Equation 4 )\end{matrix}$$

First complex transfer function calculator 150 calculates this for different elements in all subcarrier directions, transmission antenna element directions, and reception antenna element directions, and calculates a first complex transfer function matrix that includes the calculated plurality of elements.

Although the present embodiment describes a case where there are two or more reception antenna elements, when there is one reception antenna element, a matrix in the transmission antenna element direction and subcarrier direction may be used for Equation 1.

Although the present embodiment describes a case where there are two or more transmission antenna elements, when there is one transmission antenna element, the first error may be inhibited by dividing each element by an average value of adjacent subcarriers.

As described above, the direct wave component may be a channel component of a direct wave calculated by multiplying an eigenvector by the complex transfer function, the eigenvector being, among pairs of eigenvalues and eigenvectors calculated by performing eigenvalue decomposition of N×M×S complex transfer functions, an eigenvector paired with a maximum eigenvalue. The direct wave component may be any one complex transfer function of the N×M×S complex transfer functions, or may be an average of the N×M×S complex transfer functions. The direct wave component may be a channel component of a direct wave calculated by multiplying left singular vectors and right singular vectors by the complex transfer function, the left singular vectors and right singular vectors being calculated by performing singular value decomposition of N×M×S complex transfer functions.

### [Second Complex Transfer Function Calculator 160]

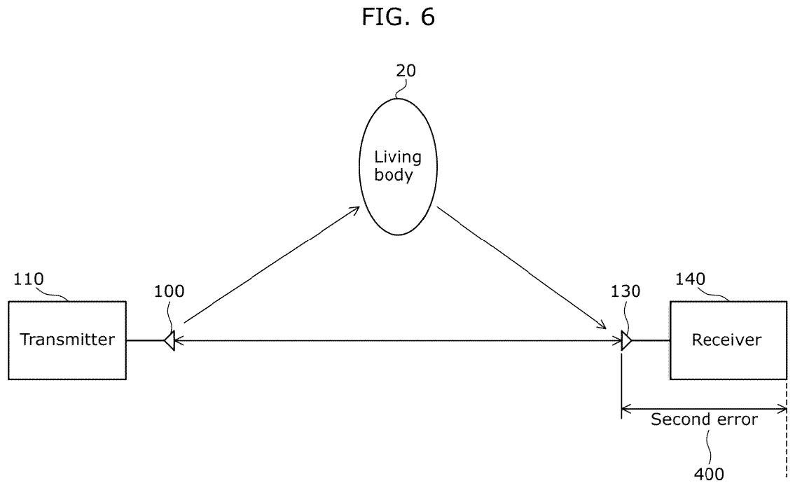

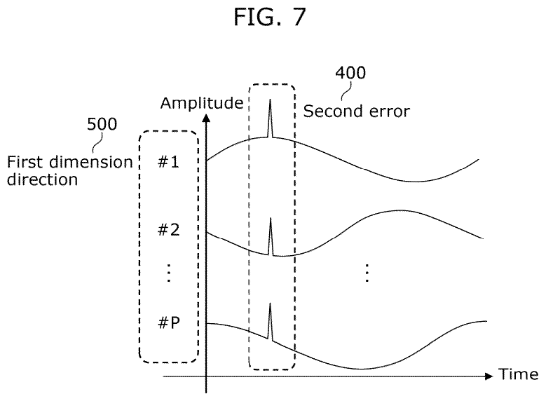

FIG. 6 and FIG. 7 are diagrams schematically illustrating an example of a second error.

In the present embodiment, second complex transfer function calculator 160 performs predetermined processing for inhibiting second error 400, which is an error within the reception device, using an amplitude average of a plurality of first elements arranged in first dimension direction 500 from first complex transfer function calculator 150. In the present embodiment, second complex transfer function calculator 160 calculates a second complex transfer function matrix in which second error 400 is inhibited based on an amplitude average of a plurality of first elements in the transmission antenna element direction as first dimension direction 500. An element of the second complex transfer function matrix where the s-th subcarrier is transmitted from the m-th transmission antenna and received by the n-th reception antenna is represented by Equation 5.

$$\begin{matrix}[ Math . 5 ] & \\ {h}_{nm}^{″} ( t , s ) = \frac{{h}_{nm}^{′} ( t , s )}{\frac{1}{M} {\sum }_{m = 1}^{M} \vert {h}_{nm}^{′} ( t , s ) \vert} & ( Equation 5 )\end{matrix}$$

The signal after amplification processing by receiver 140 includes, as illustrated in FIG. 7, a second error due to amplification processing as an error within the reception device. The second error appears with approximately the same amplitude at the same timing regardless of transmission antenna element or subcarrier. Accordingly, by calculating an amplitude average for a plurality of first elements derived from reception signals received by the same reception antenna element, it is possible to extract noise components that are common to these first elements. By dividing each of the plurality of first elements by the extracted noise component, it is possible to calculate elements from which the noise component has been removed.

Second complex transfer function calculator 160 calculates this for different elements in all subcarrier directions, transmission antenna element directions, and reception antenna element directions, and calculates a second complex transfer function matrix that includes the calculated plurality of elements.

In this manner, second complex transfer function calculator 160 calculates a second complex transfer function matrix by performing predetermined processing on each of N×M×S elements in a first complex transfer function matrix that includes, as each element of an N×M×S three-dimensional array, complex transfer functions obtained for each of the S subcarriers and each of the N×M combinations. The predetermined processing is processing that calculates an amplitude average of a plurality of first elements including an element to be processed, and divides the element to be processed by the amplitude average. The plurality of first elements are included in S×M elements obtained for one reception antenna element corresponding to the element to be processed.

In the present embodiment, an amplitude average of a plurality of first elements arranged in the transmission antenna element direction of the first complex transfer function matrix was used to calculate the second complex transfer function matrix, but an amplitude average of a plurality of first elements in the subcarrier direction or both may be used. Stated differently, the plurality of first elements for calculating the amplitude average may be M elements obtained for one reception antenna element corresponding to the element to be processed and one subcarrier corresponding to the element to be processed. The plurality of first elements for calculating the amplitude average may be S elements obtained for one reception antenna element corresponding to the element to be processed and one transmission antenna element corresponding to the element to be processed. The plurality of first elements for calculating the amplitude average may be S×M elements obtained for one reception antenna element corresponding to the element to be processed.

In the present embodiment, the second complex transfer function matrix is calculated using an amplitude average of a plurality of first elements, but it may be calculated using a phase average of a plurality of first elements or an average value of both. Stated differently, the second complex transfer function matrix may include a plurality of elements obtained by dividing each element of the first complex transfer function matrix by a phase average of a plurality of first elements or an average value of both.

In the present embodiment, the amplitude average used all of the plurality of first elements for the amplitude average in the transmission antenna element direction or subcarrier direction of the first complex transfer function, but an average value of a plurality of first elements arranged in the transmission antenna direction with the element to be processed as a reference, or a plurality of first elements arranged in the subcarrier direction with the element to be processed as a reference, or some elements of the plurality of first elements arranged planarly in the transmission antenna direction and subcarrier direction with the element to be processed as a reference (that is, an arbitrary number (two or more)) may be used.

In the present embodiment, the second complex transfer function matrix is calculated based on the first complex transfer function matrix after calculation of the first complex transfer function matrix, but the order of calculation may be reversed. Stated differently, the first complex transfer function matrix may be calculated based on the second complex transfer function matrix after calculation of the second complex transfer function matrix.

### [Third Complex Transfer Function Calculator 170]

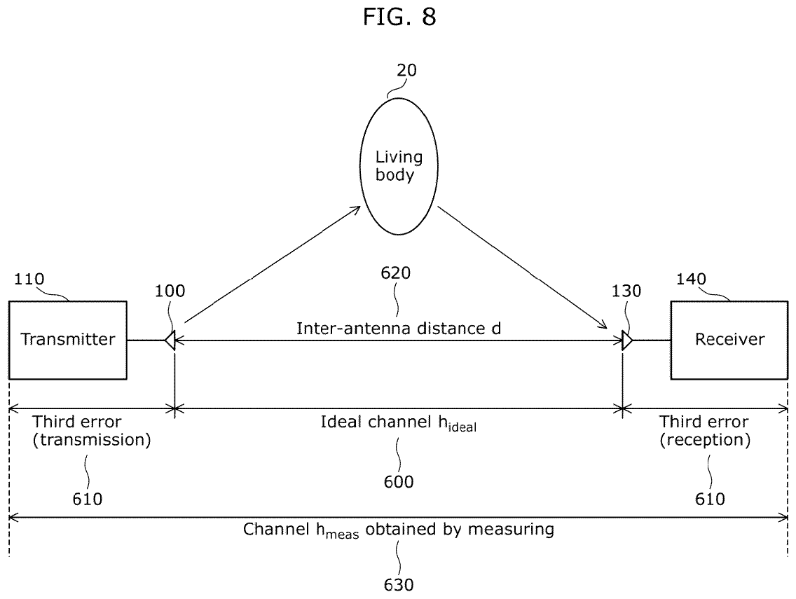

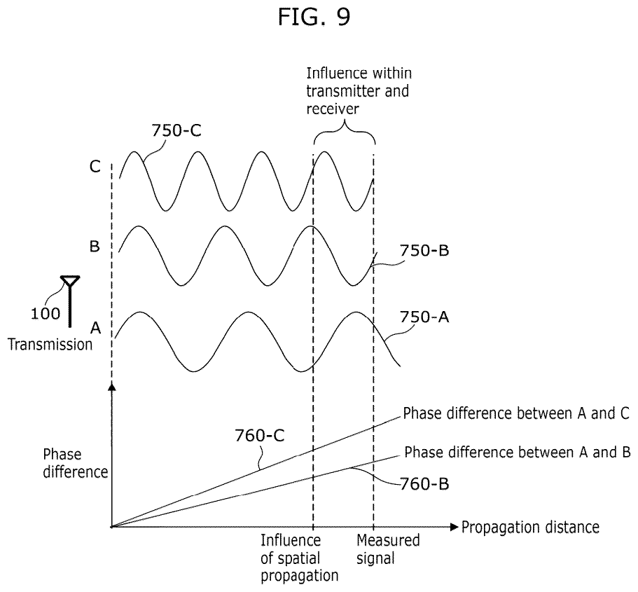

FIG. 8 is a diagram schematically illustrating an example of a third error, and FIG. 9 is a schematic diagram illustrating the relationship between the third error and a channel.

Third complex transfer function calculator 170 receives channel 630 obtained by measurement or the calculated second complex transfer function, and calibrates (corrects) third error 610, which is a phase error in the frequency direction. The phase error in the frequency direction is a phase error between a plurality of signals having mutually different frequencies. Phase errors that require calibration will be described with reference to FIG. 9.

When signals of different frequencies propagate through a space and are received, the amount of phase rotation by transmission signal 310 with respect to reception signal 320 is different depending on the frequency and the distance between transmission antenna 100 and reception antenna 130 (hereafter referred to as inter-antenna distance). FIG. 9 illustrates three transmission waves 750-A, 750-B, and 750-C, which are signals with mutually different frequencies transmitted from transmission antenna 100 with the same phase, and it can be seen that the phases continue to differ as the propagation distance increases (760-B, 760-C). Accordingly, the inter-antenna distance can be calculated by transmitting and receiving signals having a plurality of already-known frequencies, measuring phase differences, and performing back calculation. However, the phase difference that is actually measured includes, not only the influence of spatial propagation between transmission antenna 100 and reception antenna 130, but also error due to the influence of phase characteristics of internal circuits of the transmission device and reception device, antennas, etc. (hereinafter referred to as third error 610). Accordingly, in order to correctly measure the inter-antenna distance, it is necessary to remove third error 610 from the measured signal.

Third error 610 can be calculated by calculating the difference between channel hₘₑₐₛ obtained by measurement and ideal channel h_{ideal}, which is a channel of the space that can be calculated from the second complex transfer function and the distance between the transmission antenna element and reception antenna element. This is not limited to estimating the inter-antenna distance but also applies to the case of estimating the distance between estimating device 101 and living body 20.

Third complex transfer function calculator 170 corrects third error 610, which is a phase error in the subcarrier direction. The direct wave component in the second complex transfer function received from second complex transfer function calculator 160 is extracted. The methods of calculating the living body component from the complex transfer functions recorded in time-series include the method using Fourier transform disclosed in PTL 1 and the method using difference information disclosed in PTL 2.

For example, in a method that uses Fourier transform, third complex transfer function calculator 170 calculates a complex transfer function corresponding to direct wave 200 by performing Fourier transform on the second complex transfer function with respect to the measurement time (slow time) and extracting only specific frequency components. Third complex transfer function calculator 170 extracts any frequency component, for example, a 0 Hz frequency component, from a frequency response complex transfer function calculated by performing Fourier transform on the second complex transfer function with respect to the measurement time, and calculates a time response complex transfer function corresponding to direct wave 200 by performing inverse Fourier transform on the frequency response complex transfer function corresponding to direct wave 200.

Next, third complex transfer function calculator 170 calculates H_{ideal}, which is ideal channel 600 between antenna elements, based on inter-antenna distance 620 between the transmission antenna element and the reception antenna element that is inputted in advance. The inputted inter-antenna distance d is, for example, a value obtained by a user actually measuring the distance between the transmission antenna element and the reception antenna element. Here, H_{ideal} is a complex number matrix of S elements (where S is the number of subcarriers), and H_{ideal}(s), which represents ideal channel 600 for the s-th subcarrier, is calculated using Equation 6.

$$\begin{matrix}[ Math . 6 ] & \\ {H}_{ideal} ( s ) = ( \begin{matrix}{e}^{- {jd}_{11} k ( s )} & ⋯ & {e}^{- {jd}_{1 M} k ( s )} \\ ⋮ & ⋱ & ⋮ \\ {e}^{- {jd}_{N 1} k ( s )} & ⋯ & {e}^{- {jd}_{NM} k ( s )}\end{matrix} ) & ( Equation 6 )\end{matrix}$$

Here, dₙₘ indicates the distance between the m-th transmission antenna and the n-th reception antenna, and k(s) indicates the wavenumber of the s-th subcarrier. In this manner, H_{ideal} is an ideal complex transfer function between the transmission antenna element and the reception antenna element obtainable based on inter-antenna distance 620 between the transmission antenna element and the reception antenna element.

Next, third complex transfer function calculator 170 calculates a correction value for correcting third error 610, which is a phase error in the subcarrier direction, based on H_{ideal}, which is ideal channel 600, and time response complex transfer function H₀ corresponding to direct wave 200. Third complex transfer function calculator 170 calculates correction value H_{cal} by calculating the difference between H_{ideal}, which is ideal channel 600, and time response complex transfer function H₀ corresponding to direct wave 200. The correction value h_{cal_nm} of third error 610 between the m-th transmission antenna element and the n-th reception antenna element at the s-th subcarrier is calculated by Equation 7.

$$\begin{matrix}[ Math . 7 ] & \\ {h}_{cal \_ nm} ( s ) = {h}_{ideal \_ nm} ( s ) ∅ {h}_{0 \_ nm} ( s ) & ( Equation 7 )\end{matrix}$$

Here, h_{cal_nm}, h_{ideal_nm}, h_{0_nm} respectively represent elements from the m-th transmission antenna to the n-th reception antenna of H_{cal}, H_{ideal}, H₀, and Ø represents Hadamard division, which is element-wise division of vectors.

Finally, third complex transfer function calculator 170 calculates a third complex transfer function matrix based on correction value H_{cal}. The third complex transfer function between the m-th transmission antenna element and the n-th reception antenna element at the s-th subcarrier is calculated by Equation 8.

$$\begin{matrix}[ Math . 8 ] & \\ {h}_{nm}^{″} ( t , s ) = {∠ h}_{cal \_ nm} ( s ) ∘ {h}_{nm}^{″} ( t , s ) & ( Equation 8 )\end{matrix}$$

Here, ∠h_{cal_nm} represents the phase angle of h_{cal_nm}, and ∘ represents Hadamard product, which is element-wise multiplication.

Third complex transfer function calculator 170 calculates this for different elements in all subcarrier directions, transmission antenna element directions, and reception antenna element directions, and calculates a third complex transfer function matrix that includes the calculated plurality of elements.

In this manner, third complex transfer function calculator 170 calculates offset values (correction values) with respect to a reference phase calculated from the positional relationship between transmission antenna 100 and reception antenna 130, and calculates a third complex transfer function matrix in which the second complex transfer function matrix is corrected based on the offset values. More specifically, third complex transfer function calculator 170 converts the second complex transfer function matrix to a frequency response matrix or frequency response vector, and extracts a frequency response matrix or frequency response vector corresponding to the direct wave between transmission antenna 100 and reception antenna 130. Third complex transfer function calculator 170 calculates an ideal complex transfer function corresponding to the direct wave, and based on (i) the ideal complex transfer function and (ii) the frequency response matrix or frequency response vector, calculates correction values as offset values for correcting phase errors in S second elements for each of the N×M combinations in the second complex transfer function matrix. Third complex transfer function calculator 170 calculates a third complex transfer function matrix in which the phase error is corrected based on the correction value.

It should be noted that in the present embodiment, time response complex transfer function H₀ corresponding to direct wave 200 is calculated by performing Fourier transform, but it may be calculated using a high-speed processing method that does not require Fourier transform as described in PTL 2.

Moreover, although time response complex transfer function H₀ corresponding to direct wave 200 is calculated by performing Fourier transform in the present embodiment, element h_{0_nm}(s) of the time response complex transfer function may be calculated by extracting an arbitrary range of real part components and imaginary part components in element h″ₙₘ(t,s) of the second complex transfer function matrix—for example, sorting real components and imaginary components in descending (or ascending) order then extracting respective values from the 10^{th} to 90^{th} percentiles—averaging them in the time direction, and dividing by the calculated average value of the elements of the second complex transfer function matrix. Stated differently, third complex transfer function calculator 170 calculates an average value of all elements or a plurality of third elements of the second complex transfer function matrix by performing averaging in each of the real part direction and the imaginary part direction. Third complex transfer function calculator 170 calculates an ideal complex transfer function corresponding to the direct wave between transmission antenna 100 and reception antenna 130, and based on the ideal complex transfer function and the calculated average value, calculates correction values as the offset values for correcting phase errors in S second elements for each of the N×M combinations in the second complex transfer function matrix. Third complex transfer function calculator 170 calculates a third complex transfer function matrix in which the phase error is corrected based on the correction value.

Here, third complex transfer function calculator 170 may further use a minimum mean square error (MMSE) filter that emphasizes the direct wave component as a reference signal by an adaptive array based on MMSE with respect to the time direction of the calculated third complex transfer function. Stated differently, third complex transfer function calculator 170 may calculate a fourth complex transfer function matrix by applying a time-direction MMSE filter in which the direct wave between transmission antenna 100 and reception antenna 130 is set as a reference signal to the second complex transfer function matrix or the third complex transfer function matrix.

It should be noted that, in the present embodiment, although a method of calculating the correction value from the measurement result of a complex transfer function is described, in cases where the correction value does not change over time, a value measured at the factory, or the like, using a measuring device such as a network analyzer, or the like, and stored in memory may be used as the correction value.

### [Living Body Correlation Matrix Calculator 180]

For each of the plurality of subcarriers and each of the N×M 180 combinations, living body correlation calculator successively records, in the time-series order in which the plurality of reception signals 320 are measured, the plurality of complex transfer function matrices calculated by third complex transfer function calculator 170. Living body correlation matrix calculator 180 extracts, for each of the plurality of subcarriers and each of the N×M combinations, components related to living body 20 from the third complex transfer function matrix or the fourth complex transfer function matrix recorded in time series and measured for the first period, in which first error 210, second error 400, and third error 610 are inhibited, to thereby calculate, for each of the plurality of subcarriers, a living body component transfer function matrix expressed by a N×M-dimension matrix.

Here, the living body component transfer function matrix is the extracted reflected wave or scattered wave (living body component) included in reception signal 320 that passed via living body 20. The methods of calculating the living body component from the third complex transfer function recorded in time-series include the method using Fourier transform disclosed in PTL 1 and the method using difference information disclosed in PTL 2.

For example, in a method that uses Fourier transform, by performing Fourier transform on the third complex transfer function matrix for the measurement time (slow time) and extracting only specific frequency components, a living body component transfer function matrix can be calculated for each of a plurality of frequency components included in frequencies that can include living body activity signatures, for example, 0.1 Hz to 3 Hz.

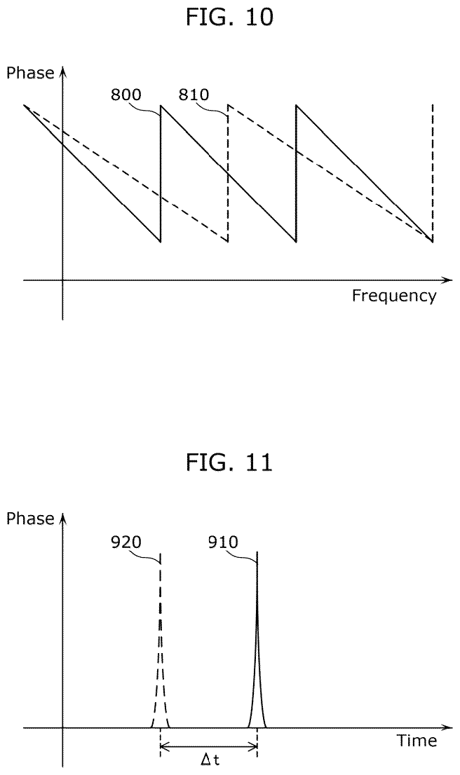

Here, the relationship between frequency and phase of the living body component transfer function matrix is illustrated in FIG. 10. Solid line 800 represents the fluctuation of the phase of each component of the living body component transfer function matrix according to the subcarrier frequency when living body 20 is present at a certain position. Since the length of the path of the radio wave reflected by living body 20 becomes shorter when living body 20 approaches transmission antenna 100 or reception antenna 130 from the aforementioned position, the slope on the graph becomes gentle and becomes like broken line 810. In principle, ToF or the distance to the living body can be estimated from this graph slope. Specifically, when the time domain living body component transfer function matrix is calculated by further performing inverse Fourier transform in the subcarrier direction on the living body component transfer function matrix, the time from when a signal including a living body component is transmitted from the transmission antenna to when the signal is received by the reception device is obtained.

FIG. 11 illustrates the relationship between the time (column direction of the matrix) and the phase of the time domain living body component transfer function matrix. The phase changes of solid line 800 and broken line 810 in FIG. 10 appear as the peaks shown by solid line 910 and broken line 920, respectively. However, temporal resolution Δt of time that is calculated here is expressed by Equation 9 using the subcarrier bandwidth B.

$$\begin{matrix}[ Math . 9 ] & \\ Δ t = \frac{1}{B} [ s ] & ( Equation 9 )\end{matrix}$$

For example, when the bandwidth is 20 MHz, the temporal resolution is equivalent to 0.5 μs or approximately 15 m when converted to distance resolution, which does not stand up to practical use.

In view of this, in the present embodiment, resolution is improved by using the MUSIC method. In order to use the MUSIC method, living body correlation matrix calculator 180 calculates living body correlation matrix R_{f} of a living body component transfer function vector obtained by vectorizing the living body component transfer function matrix according to following Equation 10.

$$\begin{matrix}[ Math . 10 ] & \\ {R}_{f} = E [ f ( {ω}^{′} ) {f ( {ω}^{′} )}^{H} ] & ( Equation 10 )\end{matrix}$$

Here, f(ω′) is a living body component transfer function vector, ω′ is a frequency range corresponding to living body activity, and E[●] denotes the average processing in the frequency direction of living body activity.

### [Estimator 190]

Estimator 190 performs ranging and angle estimation according to the MUSIC method, using living body correlation matrix Rf calculated by living body correlation matrix calculator 180. In other words, estimator 190 performs eigendecomposition of living body correlation matrix R_{f}, and calculates vector U_{S} corresponding to a signal and eigenvector U_{N} corresponding to noise. Here, eigenvectors corresponding to a signal are the vectors counted in order from a first eigenvector to the number of detection targets, and is, for example, only the first eigenvector when the target is one person. Furthermore, when the targets are k persons (k being a natural number greater than or equal to 2), the eigenvectors corresponding to a signal are the k eigenvectors from the first eigenvector to the k-th eigenvector. In addition, eigenvectors corresponding to noise refers to eigenvectors other than the eigenvectors corresponding to a signal.

Music spectrum P_{MUSIC}(x, y) is calculated according to the following equation, using eigenvectors obtained in the above-described manner.

$$\begin{matrix}[ Math . 11 ] & \\ {P}_{MUSIC} ( x , y ) = \frac{{a}^{H} ( x , y ) a ( x , y )}{{a}^{H} ( x , y ) {U}_{N} {U}_{N}^{H} a ( x , y )} & ( Equation 11 )\end{matrix}$$

Here, a(x,y) represents a steering vector, and is calculated as shown in Equation 12.

$$\begin{matrix}[ Math . 12 ] & \\ a ( x , y ) = [ {e}^{- 2 π j \frac{{d}_{11} ( x , y )}{λ ( 1 )}} , {e}^{- 2 π j \frac{{d}_{N 1} ( x , y )}{λ ( 1 )}} , … , {e}^{- 2 π j \frac{{d}_{NM} ( x , y )}{λ ( 1 )}} , {e}^{- 2 π j \frac{{d}_{11} ( x , y )}{λ ( 2 )}} , … , {e}^{{- 2 π j \frac{{d}_{NM} ( x , y )}{λ ( S )} ]}^{T}} & ( Equation 12 )\end{matrix}$$

Here, dₙₘ(x, y) indicates the sum of the distance between coordinates (x, y) and the n-th reception antenna element and the distance between coordinates (x, y) and the m-th transmission antenna element, and λ(s) indicates the wavelength of the s-th subcarrier. (x, y), which takes the maximum value in MUSIC spectrum P_{MUSIC}(x, y) obtained in the above manner, is estimated as the position of living body 20.

In the present embodiment, estimator 190 performed average processing in the living body activity frequency direction in Equation 10, but estimator 190 may further average in the subcarrier frequency direction.

In the present embodiment, estimator 190 may estimate first angle θ to the living body as viewed from the reception antenna by applying, to the MUSIC method of Equation 11, a steering vector calculated using an arbitrary subcarrier frequency according to Equation 12.

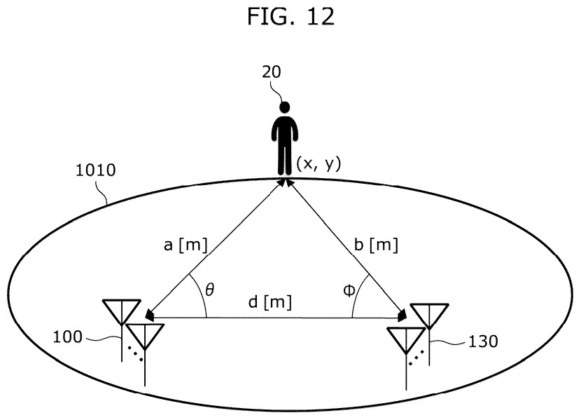

In the present embodiment, estimator 190 estimates the position of living body 20, but estimator 190 may estimate the distance between estimating device 101 and living body 20. When one arbitrary transmission antenna element and one arbitrary reception antenna element are extracted, the maximum value of P_{MUSIC}(x, y) becomes ellipse 1010 having the transmission antenna element and the reception antenna element as focal points, as illustrated in FIG. 12. The sum (third distance) of distance a (first distance) between the transmission antenna element and living body 20, and distance b (second distance) between the reception antenna element and living body 20, from an arbitrary point (x, y) on ellipse 1010 that becomes maximum with the transmission and reception antennas is calculated by Equation 13.

$$\begin{matrix}[ Math . 13 ] & \\ {P}_{MUSIC} ( l ) = \frac{{a}^{H} ( l ) a ( l )}{{a}^{H} ( l ) {U}_{N} {U}_{N}^{H} a ( l )} & ( Equation 13 )\end{matrix}$$

Here, a(l) Represents a Steering Vector, and is Calculated as Shown in Equation 14.

$$\begin{matrix}[ Math . 14 ] & \\ a ( l ) = {[ {e}^{- j \frac{2 π}{λ ( s )} l} , … , {e}^{- j \frac{2 π}{λ ( s )} l ( S - 1 )} ]}^{T} & ( Equation 14 )\end{matrix}$$

l, which takes the maximum value of MUSIC spectrum P_{MUSIC}(l) obtained in the above manner, corresponds to the sum (third distance) of distance a (first distance) between transmission antenna 100 and living body 20, and distance b (second distance) between reception antenna 130 and living body 20 in FIG. 12.

FIG. 12 is a schematic diagram illustrating the position of a living body and the positional relationship between the living body and transmission and reception antennas in a MIMO system. In FIG. 12, transmission antenna 100 includes a plurality of transmission antenna elements, and reception antenna 130 includes a plurality of reception antenna elements. Stated differently, FIG. 12 is an example of a MIMO system.

In this manner, estimator 190 estimates the third distance that is the sum of the first distance between transmission antenna 100 and living body 20 and the second distance between reception antenna 130 and living body 20, by using the living body correlation matrix calculated for each of the plurality of subcarriers.

In the present embodiment, estimator 190 estimated the living body position from Equation 13, but estimator 190 may estimate the position of living body 20 from first angle θ as illustrated in Equation 16, with the sum of estimated distance a (first distance) between transmission antenna 100 and living body 20 and distance b (second distance) between reception antenna 130 and living body 20 as third distance L.

$$\begin{matrix}[ Math . 15 ] & \\ {( L - a )}^{2} = {a}^{2} + {d}^{2} - 2 ad cos θ & ( Equation 15 )\end{matrix}$$

$$a ( 2 d cos θ - 2 L ) = {d}^{2} - {L}^{2}$$

$$∴ a = \frac{{L}^{2} - {d}^{2}}{2 ( L - d cos θ )}$$

The coordinates (x, y) of living body 20 are calculated using first distance a and first angle θ according to the following equation.

$$\begin{matrix}[ Math . 15 ] & \\ ( x , y ) = ( a cos θ , a sin θ ) & ( Equation 16 )\end{matrix}$$

It should be noted that, as will be described later, estimator 190 may estimate the position of living body 20 from second angle φ as illustrated in Equation 32, with the sum of estimated distance a (first distance) between transmission antenna 100 and living body 20 and distance b (second distance) between reception antenna 130 and living body 20 as third distance L.

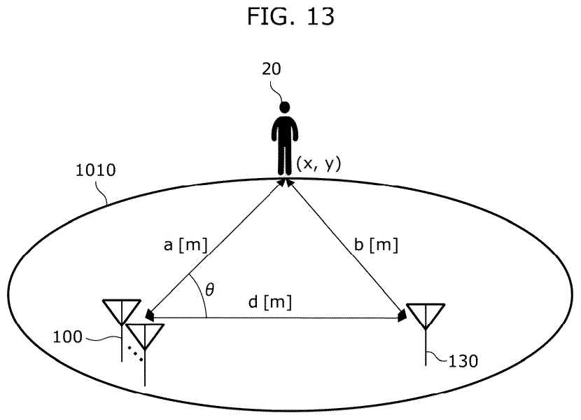

Similarly, estimator 190 may select one antenna from a plurality of transmission antenna elements as illustrated in FIG. 13, and calculate the sum (third distance) of distance a (first distance) between transmission antenna 100 and living body 20 and distance b (second distance) between reception antenna 130 and living body 20 as illustrated in Equation 13.

FIG. 13 is a schematic diagram illustrating the position of a living body and the positional relationship between the living body and transmission and reception antennas in a MISO system. In FIG. 13, transmission antenna 100 includes a plurality of transmission antenna elements, and reception antenna 130 includes one reception antenna element. Stated differently, FIG. 13 is an example of a MISO system.

l, which takes the maximum value of MUSIC spectrum P_{MUSIC}(l) obtained in the above manner, corresponds to the sum (third distance) of distance a (first distance) between transmission antenna 100 and living body 20, and distance b (second distance) between reception antenna 130 and living body 20 in FIG. 13. In this manner, estimator 190 estimates the third distance that is the sum of the first distance between transmission antenna 100 and living body 20 and the second distance between reception antenna 130 and living body 20, by using the living body correlation matrix calculated for each of the plurality of subcarriers.

In the present embodiment, estimator 190 estimated the position of living body 20 from Equation 13, but estimator 190 may estimate the position of living body 20 from first angle θ as illustrated in Equation 16, with the third distance as L, where the third distance is the sum of estimated distance a (first distance) between transmission antenna 100 and living body 20 and distance b (second distance) between reception antenna 130 and living body 20.

### [Operation of Estimating Device 101]

The operation in the estimation process by estimating device 101 configured in the above-described manner will be described.

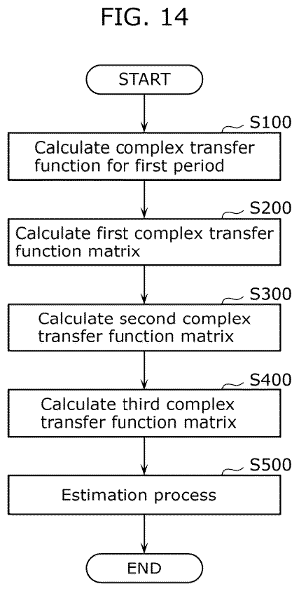

FIG. 14 is a flowchart illustrating the estimation process by the estimating device according to Embodiment 1.

Estimating device 101 calculates the complex transfer function for the first period (S100).

Next, estimating device 101 calculates a first complex transfer function matrix in which first error 210 corresponding to at least one of the following is inhibited: (i) clock fluctuations between transmitter 110 and receiver 140 or (ii) timing fluctuations in digital-to-analog conversion of transmission signal 310 or analog-to-digital conversion of reception signal 320 (S200).

Next, estimating device 101 calculates a second complex transfer function matrix in which second error 400, which is a reception internal error, is inhibited (S300).

Next, estimating device 101 calculates a third complex transfer function matrix in which third error 610, which is a phase error in the subcarrier direction, is inhibited (S400).

Lastly, estimating device 101 performs an estimation process for the direction, distance, and/or position of living body 20 (S500).

It should be noted that the details of the processing of each step are omitted because they are included in the description of the configuration of estimating device 101.

### Advantageous Effects, Etc.

Estimating device 101 according to the present embodiment is a device that estimates a reception internal error, and includes transmission signal generator 120, transmission antenna 100, transmitter 110, reception antenna 130, receiver 140, and matrix calculator 145. Transmission signal generator 120 generates a multicarrier signal obtained by modulating S subcarrier signals, where S is a natural number greater than or equal to 2. Transmission antenna 100 includes M (M is a natural number of at least 1) transmission antenna elements. Transmitter 110 causes transmission antenna 100 to transmit the multicarrier signal, by processing and outputting the multicarrier signal to transmission antenna 100. Reception antenna 130 includes N (N is a natural number of at least 1) reception antenna elements. Receiver 140 measures, for a first period equivalent to a cycle derived from an activity of living body 20, the reception signals that are received by each of the N reception antenna elements and include reflected signals which are the multicarrier signals transmitted from each of the M transmission antenna elements that have been reflected or scattered by living body 20. Receiver 140 calculates, for each of the S subcarriers to which the S subcarrier signals correspond, a plurality of complex transfer functions indicating a propagation characteristic between a transmission antenna element and a reception antenna element in each of N×M combinations which are combinations of each of the M transmission antenna elements and each of the N reception antenna elements, using the plurality of reception signals measured in the first period. Matrix calculator 145 calculates a second complex transfer function matrix by performing predetermined processing on each of N×M×S elements in a first complex transfer function matrix that includes, as each element of an N×M×S three-dimensional array, complex transfer functions obtained for each of the S subcarriers and each of the N×M combinations. The predetermined processing is processing that calculates an amplitude average of a plurality of first elements including an element to be processed, and divides the element to be processed by the amplitude average. The plurality of first elements are included in S×M elements obtained for one reception antenna element corresponding to the element to be processed.

With this, predetermined processing that calculates an amplitude average of a plurality of first elements that are included in S×M elements obtained for one reception antenna element corresponding to the element to be processed and that include the element to be processed, and divides the element to be processed by the amplitude average, is performed on each of N×M×S elements in the first complex transfer function matrix, so that a first error given to a reception signal by the reception antenna element can be reduced for each reception antenna element. Therefore, it is possible to accurately estimate the position and the like of living body 20.

In estimating device 101 according to the present embodiment, the plurality of first elements are M elements obtained for the one reception antenna element corresponding to the element to be processed and one subcarrier corresponding to the element to be processed.

Accordingly, by using an amplitude average of M elements obtained for one reception antenna element corresponding to the element to be processed and one subcarrier corresponding to the element to be processed, the first error can be reduced.

In estimating device 101 according to the present embodiment, the plurality of first elements are S elements obtained for the one reception antenna element corresponding to the element to be processed and one transmission antenna element corresponding to the element to be processed.

Accordingly, by using an amplitude average of S elements obtained for one reception antenna element corresponding to the element to be processed and one transmission antenna element corresponding to the element to be processed, the first error can be reduced.

In estimating device 101 according to the present embodiment, the plurality of first elements are the S×M elements.

Accordingly, by using an amplitude average of S×M elements, the first error can be reduced.

In estimating device 101 according to the present embodiment, matrix calculator 145 further calculates an offset value with respect to a reference phase calculated from the positional relationship between transmission antenna 100 and reception antenna 130, and calculates a third complex transfer function matrix in which the second complex transfer function matrix is corrected based on the offset value.

With this, the third error with respect to the reference phase can be reduced, and therefore it is possible to more accurately estimate the position and the like of living body 20.

In estimating device 101 according to the present embodiment, matrix calculator 145 converts the second complex transfer function matrix to a frequency response matrix or frequency response vector, and extracts a frequency response matrix or frequency response vector corresponding to the direct wave between transmission antenna 100 and reception antenna 130. Matrix calculator 145 calculates an ideal complex transfer function corresponding to the direct wave, and based on (i) the ideal complex transfer function and (ii) the frequency response matrix or frequency response vector, calculates correction values as offset values for correcting phase errors in S second elements for each of the N×M combinations in the second complex transfer function matrix. Matrix calculator 145 calculates a third complex transfer function matrix in which the phase error is corrected based on the correction value.

Accordingly, phase error in the subcarrier direction can be removed, and thus the distance from estimating device 101 to living body 20 can be more accurately estimated.

In estimating device 101 according to the present embodiment, matrix calculator 145 calculates an average value of all elements or a plurality of third elements of the second complex transfer function matrix by performing averaging in each of the real part direction and the imaginary part direction. Matrix calculator 145 calculates an ideal complex transfer function corresponding to the direct wave between transmission antenna 100 and reception antenna 130, and based on the ideal complex transfer function and the average value, calculates, as the offset value, a correction value for correcting a phase error in S second elements for each of the N×M combinations in the second complex transfer function matrix. Matrix calculator 145 calculates a third complex transfer function matrix in which the phase error is corrected based on the correction value.

Accordingly, phase error in the subcarrier direction can be removed, and thus the distance from estimating device 101 to living body 20 can be more accurately estimated.

In estimating device 101 according to the present embodiment, matrix calculator 145 further calculates a fourth complex transfer function matrix by applying, to the second complex transfer function matrix or the third complex transfer function matrix, a time-direction Minimum Mean Square Error (MMSE) filter in which a direct wave between transmission antenna 100 and reception antenna 130 is set as a reference signal.

Accordingly, phase error in the subcarrier direction can be removed, and thus the distance from estimating device 101 to living body 20 can be more accurately estimated.

In estimating device 101 according to the present embodiment, the first complex transfer function matrix includes N×M×S corrected elements obtained by dividing all elements of N×M×S complex transfer functions by a direct wave component that has not arrived via living body 20 and is extracted using one or more elements of the N×M×S complex transfer functions, the N×M×S complex transfer functions being a set of the complex transfer functions obtained for each of the S subcarriers and each of the N×M combinations.

With this, a first error, which is a component corresponding to at least one of the following, can be reduced: (1) clock fluctuations between a transmission device including a transmission signal generator that transmits from a transmission antenna and a transmitter, and a reception device including a receiver that receives via a reception antenna; or (2) timing fluctuations in digital-to-analog conversion of the transmission signal or analog-to-digital conversion of the reception signal. Therefore, it is possible to more accurately estimate the position and the like of living body 20.

In estimating device 101 according to the present embodiment, M and N are greater than or equal to 2. Estimating device 101 further includes estimator 190. Estimator 190 estimates a position of living body 20 from a first angle and a second angle, using the third complex transfer function matrix calculated by matrix calculator 145, the first angle indicating a direction of living body 20 as seen from M transmission antennas 100, the second angle indicating a direction of living body 20 as seen from N reception antennas 130.

Accordingly, the position of living body 20 relative to estimating device 101 can be more accurately estimated.

In estimating device 101 according to the present embodiment, M is greater than or equal to 2, and N is 1. Estimating device 101 further includes estimator 190. Estimator 190 estimates, using the third complex transfer function matrix calculated by matrix calculator 145, a third distance that is a sum of a first distance between transmission antenna 100 and living body 20 and a second distance between reception antenna 130 and living body 20, and estimates a first angle indicating a direction of living body 20 as seen from transmission antenna 100, and estimates a position of living body 20 from the third distance and the first angle.

Accordingly, the position of living body 20 relative to estimating device 101 can be more accurately estimated.

In estimating device 101 according to the present embodiment, estimator 190 estimates the first distance, the second distance, the first angle, and the second angle using any one of a multiple signal classification (MUSIC) method, a beamformer method, or Capon method.

Accordingly, the distance to living body 20 relative to estimating device 101 can be more accurately estimated.

In this manner, according to the present embodiment, estimating device 101 with a MIMO or MISO configuration can be used to estimate the position (coordinates) of living body 20, the distance between transmission antenna 100 and reception antenna 130 and living body 20, and the direction (angle) in which living body 20 exists relative to transmission antenna 100 and reception antenna 130.

As described above, the present disclosure can realize an estimating device, an estimating method, and a program that are capable of quickly and accurately estimating the distance or position of a living body by using radio signals.

### Embodiment 2

In Embodiment 2, a method for detecting a living body in the case of a single input multiple output (SIMO) scheme in which the transmission antenna is a single antenna and the reception antenna includes a plurality of antenna elements will be described. The present disclosure can similarly be applied to a single input single output (SISO) scheme in which both the transmission antenna and reception antenna are single antennas.

### [Configuration of Estimating Device 1201]

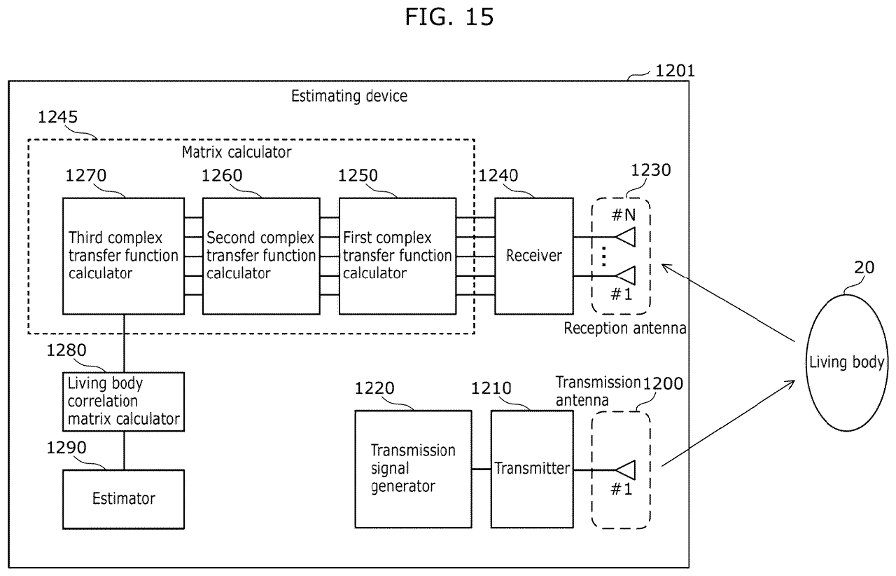

FIG. 15 is a block diagram illustrating an example of a configuration of estimating device 1201 according to Embodiment 2.

Estimating device 1201 illustrated in FIG. 15 includes transmission antenna 1200, transmitter 1210, transmission signal generator 1220, reception antenna 1230, receiver 1240, matrix calculator 1245, living body correlation matrix calculator 1280, and estimator 1290. Matrix calculator 1245 includes first complex transfer function calculator 1250, second complex transfer function calculator 1260, and third complex transfer function calculator 1270. Estimating device 1201 estimates the position of living body 20.

### [Transmission Antenna 1200]

Transmission antenna 1200 includes one transmission antenna element. As described above, the transmission antenna element transmits a multicarrier signal (transmission wave) generated by transmitter 1210 to be described later.

### [Transmission Signal Generator 1220]

Transmission signal generator 1220 generates a multicarrier signal obtained by modulating a plurality of subcarrier signals. Specifically, transmission signal generator 1220 generates a plurality of subcarrier signals corresponding to a plurality of subcarriers having mutually different frequency bands, and generates a multicarrier signal by multiplexing the generated plurality of subcarrier signals. In the present embodiment, an example will be given in which transmission signal generator 1220 generates, as a multicarrier signal, an OFDM signal of S subcarriers, which offers high frequency band utilization efficiency. Note that transmission signal generator 1220 is not limited to generating an OFDM signal in which respective subcarriers are orthogonal, and may generate other multicarrier signals such as a simple frequency division multiplexing (FDM) signal as long as it is a multicarrier signal obtainable by multicarrier modulation.

Furthermore, the signal generated by transmission signal generator 1220 may be a signal that is shared with a signal used for communication. Stated differently, the transmission signal used for sensing living body 20 may be used exclusively for sensing living body 20, or may be used for both sensing living body 20 and for communicating information.

### [Transmitter 1210]

Transmitter 1210 adds appropriate processing to the signal generated by transmission signal generator 1220, to generate a transmission wave. The processing carried out here includes, for example, up-conversion in which the signal is converted from the intermediate frequency (IF) frequency band to the radio frequency (RF) frequency band, amplification in which the signal is amplified to the appropriate transmission level, etc. Transmitter 1210 outputs the processed multicarrier signal to transmission antenna 1200 to thereby cause transmission antenna 1200 to transmit the multicarrier signal. With this, the multicarrier signal is transmitted from the one transmission antenna element included in transmission antenna 1200.

### [Reception Antenna 1230]

Reception antenna 1230 includes N reception antenna elements. Here, N is a natural number greater than or equal to 1. Note that in the present embodiment, N in the case of SIMO is a natural number greater than or equal to 2, and N in the case of SISO is 1. The N reception antenna elements receive signals that were transmitted by the one transmission antenna element and reflected by living body 20 (i.e., reception signals 320).

### [Receiver 1240]

Receiver 1240 measures, for a first period equivalent to a cycle derived from an activity of living body 20, reception signals 320 that are received by the N reception antenna elements and include reflected signals which are the multicarrier signal transmitted from the single transmission antenna element that has been reflected or scattered by living body 20. A cycle derived from the activity of the living body is a living body-derived cycle (living body fluctuation cycle) which is a time period greater than or equal to a half-cycle of any of the cycles of respiration, heartbeat, and body motion of living body 20.

Receiver 1240 converts the high-frequency signal received by the N reception antenna elements into a low-frequency signal on which signal processing can be performed. Receiver 1240 amplifies the signal received by the N reception antenna elements. Receiver 1240 then demodulates the OFDM signal into S subcarrier signals (IQ symbols).

Receiver 1240 further calculates, from the plurality of IQ symbols measured in the first period, a plurality of complex transfer functions indicating propagation characteristics between transmission antenna elements and reception antenna elements for each subcarrier.

Note that receiver 1240 may continue to measure reception signal 320 already received by reception antenna 1230, and continuously or periodically output S low-frequency signals (IQ symbols).

Receiver 1240 calculates, for each of a plurality of subcarriers to which the plurality of subcarrier signals correspond, a plurality of complex transfer functions indicating a propagation characteristic between a transmission antenna element and a reception antenna element in each of all N combinations of one transmission antenna element and the N reception antenna elements, using the plurality of reception signals 320 measured in the first period.

Receiver 1240 calculates, for estimating device 1201, S×N sets of complex transfer functions indicating the propagation characteristics between each transmission antenna element and each reception antenna element. In this way, receiver 1240 may generate a complex transfer function matrix having S×N elements. It should be noted that the calculated complex transfer function matrix also includes reflected waves that did not arrive via living body 20, such as direct waves and reflected waves derived from a fixed object.

Note that receiver 1240 may constantly calculate the complex transfer function matrix using each of the plurality of subcarrier signals that are outputted continuously or on a regular basis. By adopting this configuration, when estimating device 1201 shares the hardware of a communication device, the complex transfer function matrix that is normally calculated for use in processing by the communication device can also be used by estimating device 1201.

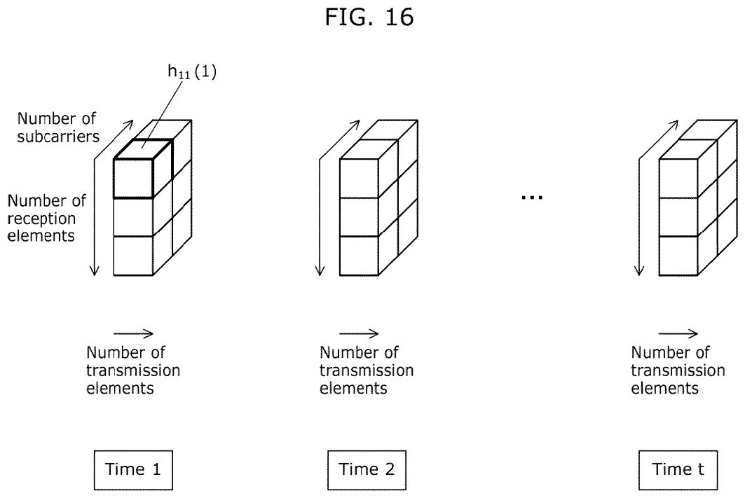

FIG. 16 is a diagram for explaining propagation characteristics at different time points in a SIMO system.

As described above, propagation characteristic H includes a complex transfer function for each combination of two types of parameters: each reception antenna element and each subcarrier. Stated differently, different complex transfer functions are calculated for each of a plurality of different reception antenna elements and for each of a plurality of different subcarriers.

FIG. 16 illustrates an image of propagation characteristic h(t) expressed by a combination of complex transfer functions in the case where the number of reception antenna elements is three, the number of transmission antenna elements is one, and the number of subcarriers is two. Propagation characteristic h(t) in this case can be expressed as a combination of 3×1×2 blocks. One block represents one complex transfer function calculated for one specific reception antenna element, one transmission antenna element, and one specific subcarrier. In this way, propagation characteristic H is expressed two-dimensionally because it is represented by two types of parameters: each reception antenna element and each subcarrier. Furthermore, this propagation characteristic h(t) is calculated for each of a plurality of timings.

In the present embodiment, propagation characteristic H(t) between the transmission antenna element and N reception antenna elements for the s-th subcarrier in the period of measurement time t is represented as illustrated in Equation 17. This is determined from the S IQ symbols transmitted from receiver 1240.

$$\begin{matrix}[ Math . 17 ] & \\ H ( t ) = ( \begin{matrix}{h}_{11} ( t ) & … & {h}_{1 S} ( t ) \\ ⋮ & ⋱ & ⋮ \\ {h}_{N 1} ( t ) & … & {h}_{NS} ( t )\end{matrix} ) & ( Equation 17 )\end{matrix}$$

### [First Complex Transfer Function Calculator 1250]

First complex transfer function calculator 1250 calculates a first complex transfer function matrix in which first error 210 corresponding to at least one of the following is inhibited from the complex transfer function matrix: (i) clock fluctuations between transmitter 1210 and receiver 1240 or (ii) timing fluctuations in digital-to-analog conversion of transmission signal 310 or analog-to-digital conversion of reception signal 320.

First complex transfer function calculator 1250 obtains eigenvectors by performing eigenvalue decomposition of a correlation matrix of the complex transfer function over a fixed measurement period or the entire measurement period, and then calculates a first complex transfer function matrix from a first eigenvector. From propagation characteristic H(t), transmission direction correlation matrix R_{R} and transmission direction correlation matrix R_{T} are calculated as illustrated in Equation 18 and Equation 19, respectively.

$$\begin{matrix}[ Math . 18 ] & \\ {R}_{R} = H ( {t}_{0} ) {H}^{H} ( {t}_{0} ) & ( Equation 18 )\end{matrix}$$

$$\begin{matrix}[ Math . 19 ] & \\ {R}_{T} = {H}^{H} ( {t}_{0} ) H ( {t}_{0} ) & ( Equation 19 )\end{matrix}$$

Here, t₀ represents instantaneous measurement time.

First complex transfer function calculator 1250 performs eigenvalue decomposition of the transmission correlation matrix and the reception correlation matrix, and calculates transmission first eigenvector v₁ and reception first eigenvector u₁. An element of the first complex transfer function where the s-th subcarrier is transmitted from the transmission antenna and received by the n-th reception antenna is calculated by Equation 20.

$$\begin{matrix}[ Math . 20 ] & \\ {h}_{ns}^{′} ( t ) = \frac{{h}_{n s} ( t )}{{u}_{1}^{H} {h}_{n s} ( {t}_{0} ) {v}_{1}} & ( Equation 20 )\end{matrix}$$

First complex transfer function calculator 1250 calculates this for different elements in all subcarrier directions, transmission antenna element directions, and reception antenna element directions, and calculates a first complex transfer function matrix that includes the calculated plurality of elements.

Although the present embodiment describes a case where there are two or more reception antenna elements, when there is one reception antenna element, the first error may be inhibited by dividing by an average value of adjacent subcarriers.

### [Second Complex Transfer Function Calculator 1260]

In the present embodiment, second complex transfer function calculator 1260 performs predetermined processing for inhibiting second error 400, which is an error within the reception device, using an amplitude average of a plurality of first elements arranged in first dimension direction 500 from first complex transfer function calculator 1250. In the present embodiment, second complex transfer function calculator 1260 calculates a second complex transfer function matrix in which second error 400, which is an error within the reception device, is inhibited based on an amplitude average of a plurality of first elements in the subcarrier direction as first dimension direction 500. An element of the second complex transfer function matrix where the s-th subcarrier is transmitted from the transmission antenna and received by the n-th reception antenna is represented by Equation 21.

$$\begin{matrix}[ Math . 21 ] & \\ {h}_{ns}^{″} ( t ) = \frac{{h}_{ns}^{′} ( t )}{\frac{1}{S} {\sum }_{s = 1}^{S} \vert {h}_{ns}^{′} ( t ) \vert} & ( Equation 21 )\end{matrix}$$

Second complex transfer function calculator 1260 calculates this for different elements in all subcarrier directions and reception antenna element directions, and calculates a second complex transfer function matrix that includes the calculated plurality of elements.

In the present embodiment, the amplitude average used all of the plurality of first elements for the amplitude average in the subcarrier direction of the first complex transfer function, but an average value of a plurality of first elements arranged in the transmission antenna direction with the element to be processed as a reference, or a plurality of first elements arranged in the subcarrier direction with the element to be processed as a reference, or some elements of the plurality of first elements arranged planarly in the transmission antenna direction and subcarrier direction with the element to be processed as a reference (that is, an arbitrary number (two or more)) may be used.

In the present embodiment, the second complex transfer function matrix is calculated using an amplitude average of a plurality of first elements, but it may be calculated using a phase average of a plurality of first elements or an average value of both. Stated differently, the second complex transfer function matrix may include a plurality of elements obtained by dividing each element of the first complex transfer function matrix by a phase average of a plurality of first elements or an average value of both.

In the present embodiment, the second complex transfer function matrix is calculated based on the first complex transfer function matrix after calculation of the first complex transfer function matrix, but the order of calculation may be reversed. Stated differently, the first complex transfer function matrix may be calculated based on the second complex transfer function matrix after calculation of the second complex transfer function matrix.

### [Third Complex Transfer Function Calculator 1270]

Third complex transfer function calculator 1270 receives channel 630 obtained by measurement or the calculated second complex transfer function matrix, and calibrates (corrects) third error 610, which is a phase error in the frequency direction.

Third complex transfer function calculator 1270 corrects third error 610, which is a phase error in the subcarrier direction. The direct wave component in the second complex transfer function received from second complex transfer function calculator 1260 is extracted. The methods of calculating the living body component from the complex transfer functions recorded in time-series include the method using Fourier transform disclosed in PTL 1 and the method using difference information disclosed in PTL 2.

For example, in a method that uses Fourier transform, third complex transfer function calculator 1270 calculates a complex transfer function corresponding to a direct wave by performing Fourier transform on the second complex transfer function matrix with respect to the measurement time (slow time) and extracting only specific frequency components. Third complex transfer function calculator 1270 extracts any frequency component, for example, a 0 Hz frequency component, from a frequency response complex transfer function calculated by performing Fourier transform on the second complex transfer function matrix with respect to the measurement time, and calculates a time response complex transfer function corresponding to a direct wave by performing inverse Fourier transform on the frequency response complex transfer function corresponding to the direct wave.

Next, third complex transfer function calculator 1270 calculates ideal channel 600 H_{ideal} between antenna elements based on inter-antenna distance 620 between the transmission antenna element and the reception antenna element that is inputted in advance. The inputted inter-antenna distance d is, for example, a value obtained by a user actually measuring the distance between the transmission antenna element and the reception antenna element. Here, H_{ideal} is a complex number matrix of S elements (where S is the number of subcarriers), and H_{ideal}, which represents ideal channel 600, is calculated using Equation 22.

$$\begin{matrix}[ Math . 22 ] & \\ {H}_{i deal} = ( \begin{matrix}{e}^{- {jd}_{1} k ( 1 )} & … & {e}^{- {jd}_{1} k ( S )} \\ ⋮ & ⋱ & ⋮ \\ {e}^{- {jd}_{N} k ( 1 )} & … & {e}^{- {jd}_{N} k ( S )}\end{matrix} ) & ( Equation 22 )\end{matrix}$$

Here, dₙ indicates the distance between the transmission antenna and the n-th reception antenna, and k(s) indicates the wavenumber of the s-th subcarrier. In this manner, H_{ideal} is an ideal complex transfer function between the transmission antenna element and the reception antenna element obtainable based on inter-antenna distance 620 between the transmission antenna element and the reception antenna element.

Next, third complex transfer function calculator 1270 calculates a correction value for correcting third error 610, which is a phase error in the subcarrier direction, based on H_{ideal}, which is ideal channel 600, and time response complex transfer function H₀ corresponding to direct wave 200. Third complex transfer function calculator 1270 calculates correction value H_{cal} by calculating the difference between H_{ideal}, which is ideal channel 600, and time response complex transfer function H₀ corresponding to direct wave 200. The correction value h_{cal_ns} of third error 610 between the transmission antenna element and the n-th reception antenna element at the s-th subcarrier is calculated by Equation 23.

$$\begin{matrix}[ Math . 23 ] & \\ {h}_{cal \_ ns} = {h}_{ideal \_ ns} ⌀ {h}_{0 \_ ns} & ( Equation 23 )\end{matrix}$$

Here, h_{cal_ns}, h_{ideal_ns}, h_{0_ns} respectively represent elements from the transmission antenna to the n-th reception antenna of H_{cal}, H_{ideal}, H₀, and Ø represents Hadamard division, which is element-wise division of vectors.

Finally, third complex transfer function calculator 1270 calculates a third complex transfer function matrix based on correction value H_{cal}. The third complex transfer function between the transmission antenna element and the n-th reception antenna element at the s-th subcarrier is calculated by Equation 20.

$$\begin{matrix}[ Math . 24 ] & \\ {h}_{ns}^{′′′} ( t ) = ∠ {h}_{cal \_ ns} ∘ {h}_{ns}^{″} ( t ) & ( Equation 24 )\end{matrix}$$

Here, ∠h_{cal_ns} represents the phase angle of h_{cal_ns}, and ∘ represents Hadamard product, which is element-wise multiplication.

Third complex transfer function calculator 1270 calculates this for different elements in all subcarrier directions and reception antenna element directions, and calculates a third complex transfer function matrix that includes the calculated plurality of elements.

It should be noted that according to the present embodiment, time response complex transfer function H₀ corresponding to direct wave 200 is calculated by performing Fourier transform, but it may be calculated using a high-speed processing method that does not require Fourier transform as described in PTL 2.

Although time response complex transfer function H₀ corresponding to direct wave 200 is calculated by performing Fourier transform according to the present embodiment, element h_{0_ns} of the time response complex transfer function may be calculated by extracting an arbitrary range of real part components and imaginary part components in element h″ₙₛ(t) of the second complex transfer function matrix—for example, sorting real components and imaginary components in descending (or ascending) order then extracting respective values from the 10^{th} to 90^{th} percentiles—averaging them in the time direction, and dividing by the calculated average value of the elements of the second complex transfer function matrix.

Here, third complex transfer function calculator 1270 may use a minimum mean square error (MMSE) filter that emphasizes the direct wave component as a reference signal by an adaptive array based on MMSE with respect to the time direction of the calculated third complex transfer function. Stated differently, third complex transfer function calculator 170 may calculate a fourth complex transfer function matrix by applying a time-direction MMSE filter in which the direct wave between transmission antenna 100 and reception antenna 130 is set as a reference signal to the second complex transfer function matrix or the third complex transfer function matrix.

It should be noted that, according to the present embodiment, although a method of calculating the correction value from the measurement result of a complex transfer function is described, in cases where the correction value does not change over time, a value measured at the factory, or the like, using a measuring device such as a network analyzer, or the like, and stored in memory may be used as the correction value.

### [Living Body Correlation Matrix Calculator 1280]

For each of the S×N combinations, living body correlation matrix calculator 1280 successively records, in the time-series order in which the plurality of reception signals 320 are measured, the plurality of complex transfer function matrices calculated by third complex transfer function calculator 1270. Living body correlation matrix calculator 1280 extracts, for each of the S×N combinations, components related to living body 20 from the third complex transfer function matrix or the fourth complex transfer function matrix recorded in time series and measured for the first period, in which first error 210, second error 400, and third error 610 are inhibited, to thereby calculate a living body component transfer function matrix expressed by a S×N-dimension matrix.

Here, the living body component transfer function matrix is the extracted reflected wave or scattered wave (living body component) included in reception signal 320 that passed via living body 20. The methods of calculating the living body component from the third complex transfer function recorded in time-series include the method using Fourier transform disclosed in PTL 1 and the method using difference information disclosed in PTL 2.

For example, in a method that uses Fourier transform, by performing Fourier transform on the third complex transfer function matrix for the measurement time (slow time) and extracting only specific frequency components, a living body component transfer function matrix can be calculated for each of a plurality of frequency components included in frequencies that can include living body activity signatures, for example, 0.1 Hz to 3 Hz.

Temporal resolution Δt is expressed by Equation 25 using the subcarrier bandwidth B.

$$\begin{matrix}[ Math . 25 ] & \\ Δ t = \frac{1}{B} [ s ] & ( Equation 25 )\end{matrix}$$

For example, when the bandwidth is 20 MHz, the temporal resolution is equivalent to 0.5 μs or approximately 15 m when converted to distance resolution, which does not stand up to practical use.

In view of this, in the present embodiment, resolution is improved by using the MUSIC method. In order to use the MUSIC method, living body correlation matrix calculator 180 calculates living body correlation matrix R_{f} of a living body component transfer function vector obtained by vectorizing the living body component transfer function matrix according to following Equation 26.

$$\begin{matrix}[ Math . 26 ] & \\ {R}_{f} = E [ f ( {ω}^{′} ) {f ( {ω}^{′} )}^{H} ] & ( Equation 26 )\end{matrix}$$

Here, f(ω′) is a living body component transfer function vector, ω′ is a frequency range corresponding to living body activity, and E[●] denotes the average processing in the frequency direction of living body activity.

### [Estimator 1290]

Estimator 1290 performs ranging and angle estimation according to the MUSIC method, using living body correlation matrix R_{f} calculated by living body correlation matrix calculator 1280.

In other words, estimator 1290 performs eigendecomposition of living body correlation matrix R_{f}, and calculates vector U_{S} corresponding to a signal and eigenvector U_{N} corresponding to noise. Here, eigenvectors corresponding to a signal are the vectors counted in order from a first eigenvector to the number of detection targets, and is, for example, only the first eigenvector when the target is one person. Furthermore, when the targets are k persons (k being a natural number greater than or equal to 2), the eigenvectors corresponding to a signal are the k eigenvectors from the first eigenvector to the k-th eigenvector. In addition, eigenvectors corresponding to noise refers to eigenvectors other than the eigenvectors corresponding to a signal.

Music spectrum P_{MUSIC}(x, y) is calculated according to the following equation, using eigenvectors obtained in the above-described manner.

$$\begin{matrix}[ Math . 27 ] & \\ {P}_{MUSIC} ( x , y ) = \frac{{a}^{H} ( x , y ) a ( x , y )}{{a}^{H} ( x , y ) {U}_{N} {U}_{N}^{H} a ( x , y )} & ( Equation 27 )\end{matrix}$$

Here, a(x,y) represents a steering vector, and is calculated as shown in Equation 28.

$$\begin{matrix}[ Math . 28 ] & \\ a ( x , y ) = {[ {e}^{- 2 π j \frac{{d}_{1} ( x , y )}{λ ( 1 )}} , … , {e}^{- 2 π j \frac{{d}_{N} ( x , y )}{λ ( 1 )}} , {e}^{- 2 π j \frac{{d}_{1} ( x , y )}{λ ( 2 )}} , … , {e}^{- 2 π j \frac{{d}_{N} ( x , y )}{λ ( S )}} ]}^{T} & ( Equation 28 )\end{matrix}$$

Here, dₙ(x, y) indicates the sum of the distance between coordinates (x, y) and the transmission antenna element and the distance between coordinates (x, y) and the n-th reception antenna element, and λ(s) indicates the wavelength of the s-th subcarrier. (x, y), which takes the maximum value in MUSIC spectrum P_{MUSIC}(x, y) obtained in the above manner, is estimated as the position of living body 20.

In the present embodiment, estimator 1290 performed average processing in the living body activity frequency direction in Equation 26, but may further average in the subcarrier frequency direction and estimate second angle φ to the living body as viewed from the reception antenna by applying, to the MUSIC method of Equation 27, a steering vector calculated using an arbitrary subcarrier frequency according to Equation 28.

$$\begin{matrix}[ Math . 29 ] & \\ {P}_{MUSIC} ( l ) = \frac{{a}^{H} ( l ) a ( l )}{{a}^{H} ( l ) {U}_{N} {U}_{N}^{H} a ( l )} & ( Equation 29 )\end{matrix}$$

Here, a(l) represents a steering vector, and is calculated as shown in Equation 30.

$$\begin{matrix}[ Math . 30 ] & \\ a ( l ) = {[ {e}^{- j \frac{2 π}{λ ( s )} l} , … , {e}^{- j \frac{2 π}{λ ( s )} l ( S - 1 )} ]}^{T} & ( Equation 30 )\end{matrix}$$

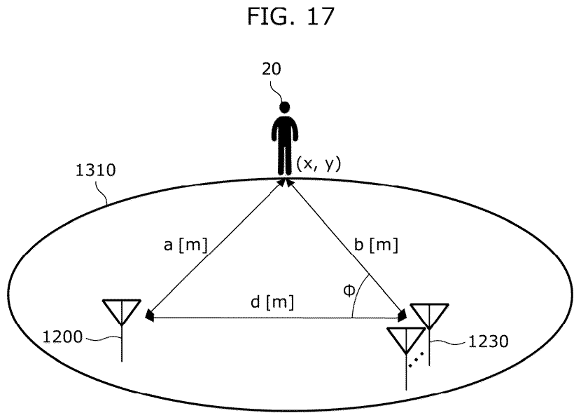

l, which takes the maximum value of MUSIC spectrum P_{MUSIC}(l) obtained in the above manner, corresponds to the sum (third distance) of distance a (first distance) between transmission antenna 1200 and living body 20, and distance b (second distance) between reception antenna 1230 and living body 20 in FIG. 17.

FIG. 17 is a schematic diagram illustrating the position of a living body and the positional relationship between the living body and transmission and reception antennas in a SIMO system. In FIG. 17, transmission antenna 1200 includes one transmission antenna element, and reception antenna 1230 includes a plurality of reception antenna elements. Stated differently, FIG. 17 is an example of a SIMO system.

In this manner, estimator 1290 estimates the third distance that is the sum of the first distance between transmission antenna 1200 and living body 20 and the second distance, by using the living body correlation matrix calculated for each of the plurality of subcarriers. In this way, estimator 1290 can estimate that living body 20 is positioned on ellipse 1310 which has the transmission antenna element and the reception antenna element as foci.

In the present embodiment, estimator 1290 estimated the living body position from Equation 29, but estimator 1290 may estimate the position of living body 20 from second angle φ as illustrated in Equation 32, with the sum of estimated distance a (first distance) between transmission antenna 1200 and living body 20 and distance b (second distance) between reception antenna 1230 and living body 20 as third distance L.

$$\begin{matrix}[ Math . 31 ] & \\ {( L - b )}^{2} = {b}^{2} + {d}^{2} - 2 bd cos φ & ( Equation 31 )\end{matrix}$$

$$b ( 2 d cos φ - 2 L ) = {d}^{2} - {L}^{2}$$

$$∴ b = \frac{{L}^{2} - {d}^{2}}{2 ( L - d cos φ )}$$

The coordinates (x, y) of living body 20 are calculated using second distance b and second angle φ according to the following equation.

$$\begin{matrix}[ Math . 32 ] & \\ ( x , y ) = ( b cos φ , b sin φ ) & ( Equation 32 )\end{matrix}$$

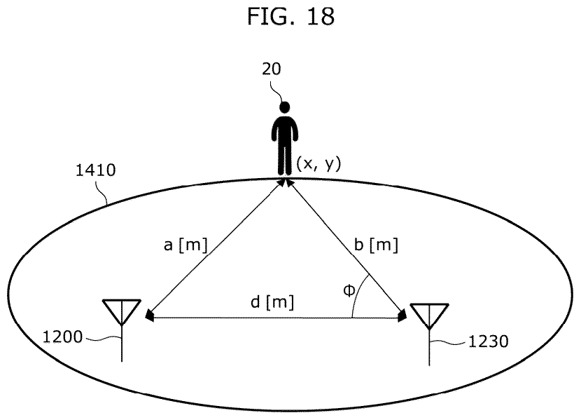

Similarly, estimator 1290 may calculate the sum (third distance) of distance a (first distance) between the transmission antenna element and living body 20 and distance b (second distance) between the reception antenna element and living body 20 as illustrated in Equation 25 when there is one reception antenna element as illustrated in FIG. 18.

FIG. 18 is a schematic diagram illustrating the position of a living body and the positional relationship between the living body and transmission and reception antennas in a SISO system. In FIG. 18, transmission antenna 1200 includes one transmission antenna element, and reception antenna 1230 includes one reception antenna element. Stated differently, FIG. 18 is an example of a SISO system.

l, which takes the maximum value of MUSIC spectrum P_{MUSIC}(l) obtained in the above manner, corresponds to the sum (third distance) of distance a (first distance) between transmission antenna 1200 and living body 20, and distance b (second distance) between reception antenna 1230 and living body 20 in FIG. 18. In this manner, the third distance that is the sum of the first distance between transmission antenna 1200 and living body 20 and the second distance between reception antenna 1230 and living body 20 is estimated, by using the living body correlation matrix calculated for each of the plurality of subcarriers. In this way, estimator 1290 can estimate that living body 20 is positioned on ellipse 1410 which has the transmission antenna element and the reception antenna element as foci. It should be noted that estimator 1290 may estimate the position of living body 20 from the intersection points of ellipses by using three or more pairs of transmission antennas 1200 and reception antennas 1230 and estimating a plurality of third distances.

### [Operation of Estimating Device 1201]

The operation in the estimation process by estimating device 1201 configured in the above-described manner will be described.

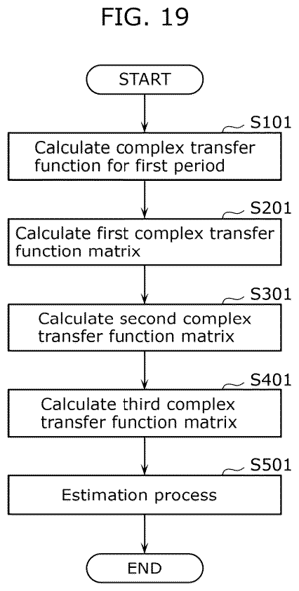

FIG. 19 is a flowchart illustrating the estimation process by the estimating device according to Embodiment 2.

Estimating device 1201 calculates the complex transfer function for the first period (S101).

Next, estimating device 1201 calculates a first complex transfer function matrix in which first error 210 corresponding to at least one of the following is inhibited: (i) clock fluctuations between transmitter 1210 and receiver 1240 or (ii) timing fluctuations in digital-to-analog conversion of transmission signal 310 or analog-to-digital conversion of reception signal 320 (S201).

Next, estimating device 1201 calculates a second complex transfer function matrix in which second error 400, which is a reception internal error, is inhibited (S301).

Next, estimating device 1201 calculates a third complex transfer function matrix in which third error 610, which is a phase error in the subcarrier direction, is inhibited (S401).

Lastly, estimating device 1201 performs an estimation process for the direction, distance, and/or position of living body 20 (S501).

It should be noted that the details of the processing of each step are omitted because they are included in the description of the configuration of estimating device 1201.

### Advantageous Effects, Etc.

In estimating device 1201 according to the present embodiment, M is 1, and N is greater than or equal to 2. Estimating device 1201 further includes estimator 1290. Estimator 1290 estimates, using the third complex transfer function matrix calculated by matrix calculator 1245, a third distance that is a sum of a first distance between transmission antenna 1200 and living body 20 and a second distance between reception antenna 1230 and living body 20, and estimates a second angle indicating a direction of living body 20 as seen from reception antenna 1230, and estimates a position of living body 20 from the third distance and the second angle.

Accordingly, the position of living body 20 relative to estimating device 1201 can be more accurately estimated.

In estimating device 1201 according to the present embodiment, M and N are 1. Estimator 1290 estimates the third distance that is the sum of the first distance between transmission antenna 1200 and living body 20 and the second distance between reception antenna 1230 and living body 20, by using the third complex transfer function matrix calculated by matrix calculator 145.

Accordingly, the distance to living body 20 relative to estimating device 1201 can be more accurately estimated.

In this manner, according to the present embodiment, estimating device with a SIMO, SISO configuration can be used to estimate the position (coordinates) of living body 20, the distance between transmission antenna 1200 and reception antenna 1230 and living body 20, and the direction (angle) in which living body 20 exists relative to transmission antenna 1200 and reception antenna 1230.

As described above, the present disclosure can realize an estimating device, an estimating method, and a program that are capable of quickly and accurately estimating the distance or position of a living body by using radio signals.

To confirm the effectiveness of the present embodiment, an experimental evaluation was conducted. This experiment will be described here.

### [Experiment]

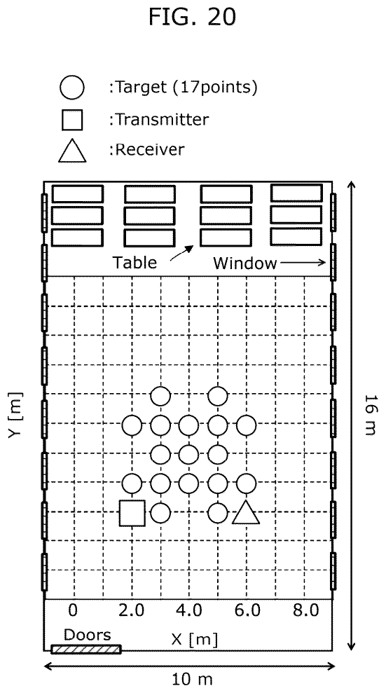

FIG. 20 illustrates conditions of an experiment using the estimating method according to the present embodiment.

FIG. 20 illustrates that both the transmission array antenna (labeled “Transmitter”) and reception array antenna (labeled “Receiver”) are 4×4 Multiple Input Multiple Output (MIMO) configurations using 4-element patch array antennas.

In this experiment, MIMO channel measurement was performed using these devices.

The array element spacing of the transmission and reception antennas was set to 0.5 wavelength, the distance between transmission and reception was set to 4.0 m, and the antenna height h was set to 1.0 m, which is the height of the chest of a human (living body) in an upright position. From the transmission device, an orthogonal frequency division multiplexing (OFDM) signal of channel 1 in the 2.4 GHz band of Wi-Fi (registered trademark) was transmitted, and the channel measurement time was set to 25.6 seconds. During channel measurement, the area was kept unoccupied except for the test subject, the test subject was positioned facing the wall on the antenna side, and one person stood at 17 circular points for measurement.

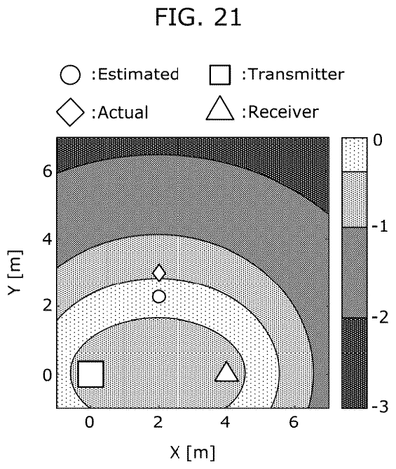

FIG. 21 illustrates results of an experiment using the estimating method according to Embodiment 1.

FIG. 21 illustrates a circle indicating the estimated point and a diamond indicating the position where the subject actually stood. The MUSIC spectrum P (see (Equation 13)) for each position in the space is shown, indicating that the test subject is estimated to exist at positions having a color close to white.

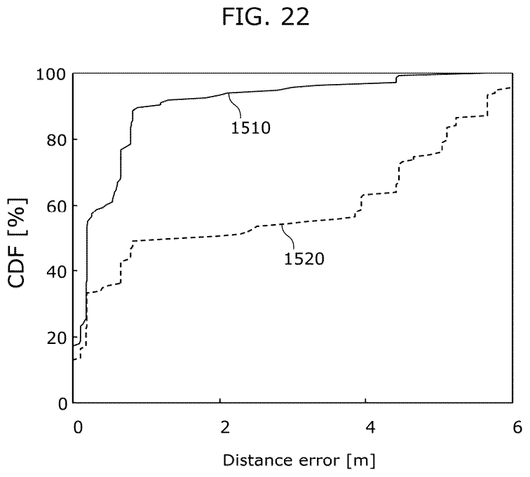

FIG. 22 illustrates results of another experiment using the estimating method according to Embodiment 1. FIG. 22 illustrates a cumulative distribution function (CDF) of distance measurement errors. Solid line 1510 illustrates results of an experiment using the estimating method according to Embodiment 1, and broken line 1520 illustrates results of an experiment using a conventional technique.

In FIG. 22, the horizontal axis indicates distance error (unit: m), and CDF with respect to the distance error is indicated on the vertical axis. In the proposed method, the CDF value for a distance error of 0.65 m is obtained as 0.75, indicating that 75% of the overall errors fall within 0.65 m. In the conventional method, 75% of the overall errors fall within 4.90 m.

Therefore, it can be seen that the estimating method according to Embodiment 1 can estimate the 75% value of distance error with 4.25 m better accuracy compared to the conventional method using CSI of full MIMO. This demonstrates that the present embodiment enables estimation of the living body position with higher accuracy.

As described above, with the present disclosure, even with Wi-Fi devices, it becomes possible to estimate the position of a living body, the distance to a living body, and the direction where a living body is by inhibiting device errors.

Although an estimating device and an estimating method according to an aspect of the present disclosure has been described above based on exemplary embodiments, the present disclosure is not limited to these exemplary embodiments. Various modifications to the exemplary embodiments that can be conceived by a person of ordinary skill in the art or forms obtained by combining elements of different embodiments, as long as they do not depart from the essence of the present disclosure, are included in the scope of the present disclosure.

For example, in Embodiments 1 and 2, the estimation of the distance to living body 20 or the estimation of the position of living body 20 relative to estimating device 101, 1201 was given as an example, but the estimation target is not limited to living body 20. The present disclosure can be applied to various moving bodies (machines, etc.) whose activity imparts a Doppler effect on reflected waves in the case where a high-frequency signal is emitted.

The present disclosure can not only be realized as a positioning sensor including such characteristic elements, but can also be realized as an estimating method with steps corresponding to the characteristic elements included in the positioning sensor. The present disclosure can also be realized as a computer program that causes a computer to execute each of the characteristic steps included in such a method. It goes without saying that such a computer program can be distributed via a non-transitory computer-readable recording medium such as CD-ROM or via a communication network such as the Internet.

### INDUSTRIAL APPLICABILITY

The present disclosure can be used for positioning sensors and distance estimating methods that estimate the distance to a living body or the position of a living body by using radio signals, and particularly, can be used for measuring instruments that measure the distance to a living body and a living body including a machine, home appliances that perform control according to the distance to a living body or the position of a living body, distance measuring sensors mounted on surveillance devices that detect intrusion of a living body, direction estimating methods, and so on.

### REFERENCE SIGNS LIST

20 living body
30 target space
101, 1201 estimating device
100, 1200 transmission antenna
110, 1210 transmitter
120, 1220 transmission signal generator
130, 1230 reception antenna
140, 1240 receiver
145, 1245 matrix calculator
150, 1250 first complex transfer function calculator
160, 1260 second complex transfer function calculator
170, 1270 third complex transfer function calculator
180, 1280 living body correlation matrix calculator
190, 1290 estimator
200 direct wave
210 first error
310 transmission signal
320 reception signal
330 direct wave+living body-derived component
400 second error
500 first dimension direction
600 ideal channel
610 third error
620 inter-antenna distance
630 channel
750-A, 750-B, 750-C phase of each subcarrier signal transmitted from transmission antenna
760-B, 760-C phase change of signals with different frequencies transmitted from transmission antenna
800, 810 phase change of complex transfer function matrix with respect to frequency
910 solid line
920 broken line
1010, 1310, 1410 ellipse where living body may be present, determined by third distance
1510 solid line
1520 broken line

1. An estimating device comprising:
a transmission signal generator that generates a multicarrier signal obtained by modulating S subcarrier signals, where S is a natural number greater than or equal to 2;
a transmission antenna including M transmission antenna elements, where M is a natural number greater than or equal to 1;
a transmitter that causes the transmission antenna to transmit the multicarrier signal, by processing and outputting the multicarrier signal to the transmission antenna;
a reception antenna including N reception antenna elements, where N is a natural number greater than or equal to 1;
a receiver that measures, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or scattered by the living body, and calculates, for each of S subcarriers to which the S subcarrier signals correspond, complex transfer functions indicating a propagation characteristic between a transmission antenna element and a reception antenna element in each of N×M combinations which are combinations of each of the M transmission antenna elements and each of the N reception antenna elements, using the plurality of reception signals measured in the first period; and
a matrix calculator that calculates a second complex transfer function matrix by performing predetermined processing on each of N×M×S elements in a first complex transfer function matrix that includes, as elements of an N×M×S three-dimensional array, the complex transfer functions obtained for each of the S subcarriers and each of the N×M combinations, wherein
the predetermined processing is processing that calculates an amplitude average of a plurality of first elements including an element to be processed, and divides the element to be processed by the amplitude average, and
the plurality of first elements are included in S×M elements obtained for one reception antenna element, among the N reception antenna elements, that corresponds to the element to be processed.

2. The estimating device according to claim 1, wherein
the plurality of first elements are M elements obtained for the one reception antenna element corresponding to the element to be processed and one subcarrier, among the S subcarriers, that corresponds to the element to be processed.

3. The estimating device according to claim 1, wherein
the plurality of first elements are S elements obtained for the one reception antenna element corresponding to the element to be processed and one transmission antenna element, among the M transmission antenna elements, that corresponds to the element to be processed.

4. The estimating device according to claim 1, wherein
the plurality of first elements are the S×M elements.

5. The estimating device according to claim 1, wherein
the matrix calculator further calculates an offset value with respect to a reference phase calculated from a positional relationship between the transmission antenna and the reception antenna, and calculates a third complex transfer function matrix in which the second complex transfer function matrix is corrected based on the offset value.

6. The estimating device according to claim 5, wherein
the matrix calculator:
converts the second complex transfer function matrix to a frequency response matrix or a frequency response vector, and extracts a frequency response matrix or a frequency response vector corresponding to a direct wave between the transmission antenna and the reception antenna;
calculates an ideal complex transfer function corresponding to the direct wave, and based on (i) the ideal complex transfer function and (ii) the frequency response matrix or the frequency response vector, calculates, as the offset value, a correction value for correcting a phase error in S second elements for each of the N×M combinations in the second complex transfer function matrix; and
calculates the third complex transfer function matrix in which the phase error is corrected based on the correction value.

7. The estimating device according to claim 5, wherein
the matrix calculator:
calculates an average value of all elements or a plurality of third elements of the second complex transfer function matrix by performing averaging in each of a real part direction and an imaginary part direction;
calculates an ideal complex transfer function corresponding to a direct wave between the transmission antenna and the reception antenna, and based on the ideal complex transfer function and the average value, calculates, as the offset value, a correction value for correcting a phase error in S second elements for each of the N×M combinations in the second complex transfer function matrix; and
calculates the third complex transfer function matrix in which the phase error is corrected based on the correction value.

8. The estimating device according to claim 5, wherein
the matrix calculator further calculates a fourth complex transfer function matrix by applying, to the second complex transfer function matrix or the third complex transfer function matrix, a time-direction Minimum Mean Square Error (MMSE) filter in which a direct wave between the transmission antenna and the reception antenna is set as a reference signal.

9. The estimating device according to claim 1, wherein
the first complex transfer function matrix includes N×M×S corrected elements obtained by dividing all elements of N×M×S complex transfer functions by a direct wave component that has not arrived via the living body and is extracted using one or more elements of the N×M×S complex transfer functions, the N×M×S complex transfer functions being a set of the complex transfer functions obtained for each of the S subcarriers and each of the N×M combinations.

10. The estimating device according to claim 5, wherein
M and N are each greater than or equal to 2, and
the estimating device further comprises an estimator that, using the third complex transfer function matrix calculated by the matrix calculator, estimates a position of the living body from a first angle and a second angle, the first angle indicating a direction of the living body as seen from the M transmission antenna elements, the second angle indicating a direction of the living body as seen from the N reception antenna elements.

11. The estimating device according to claim 5, wherein
at least one of M or N is greater than or equal to 2, and
the estimating device further comprises an estimator that, using the third complex transfer function matrix calculated by the matrix calculator, estimates a third distance that is a sum of a first distance between the transmission antenna and the living body and a second distance between the reception antenna and the living body, estimates a first angle or a second angle indicating a direction of the living body as seen from two or more antenna elements included in the transmission antenna or the reception antenna, and estimates a position of the living body from the third distance and the first angle or the second angle.

12. The estimating device according to claim 5, wherein
M and N are each 1, and
the estimating device further comprises an estimator that, using the third complex transfer function matrix calculated by the matrix calculator, estimates a third distance that is a sum of a first distance between the transmission antenna and the living body and a second distance between the reception antenna and the living body.

13. The estimating device according to claim 11, wherein
the estimator estimates the first distance, the second distance, the first angle, and the second angle using any one of a multiple signal classification (MUSIC) method, a beamformer method, or Capon method.

14. An estimating method performed by an estimating device including a transmission antenna including M transmission antenna elements, where M is a natural number greater than or equal to 1, and a reception antenna including N reception antenna elements, where N is a natural number greater than or equal to 1, the estimating method comprising:
generating a multicarrier signal obtained by modulating S subcarrier signals, where S is a natural number greater than or equal to 2;
causing the transmission antenna to transmit the multicarrier signal, by processing and outputting the multicarrier signal to the transmission antenna;
measuring, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or scattered by the living body;
calculating, for each of S subcarriers to which the S subcarrier signals correspond, complex transfer functions indicating a propagation characteristic between a transmission antenna element and a reception antenna element in each of N×M combinations which are combinations of each of the M transmission antenna elements and each of the N reception antenna elements, using the plurality of reception signals measured in the first period; and
calculating a second complex transfer function matrix by performing predetermined processing on each of N×M×S elements in a first complex transfer function matrix that includes, as elements of an N×M×S three-dimensional array, the complex transfer functions obtained for each of the S subcarriers and each of the N×M combinations, wherein
the predetermined processing is processing that calculates an amplitude average of a plurality of first elements including an element to be processed, and divides the element to be processed by the amplitude average, and
the plurality of first elements are included in S×M elements obtained for one reception antenna element, among the N reception antenna elements, that corresponds to the element to be processed.

15. A non-transitory computer-readable recording medium having recorded thereon a computer program for causing a computer to execute the estimating method according to claim 14.
